(19) United States
(12) Patent Application Publication
(10) Pub. No.: US 2026/0351096 A1
(43) Pub. Date: Nov. 5, 2026

(54) GATE APPARATUS, PROGRAM RECORDING MEDIUM, AND CHECKOUT SYSTEM

(71) Applicant: Toshiba Tec Kabushiki Kaisha, Tokyo (JP)

(72) Inventor: Ichiro FUKUZAWA, Tokyo (JP)

(21) Appl. No.: 19/713,189

(22) Filed: Jun. 18, 2026

Related U.S. Application Data
(63) Continuation of application No. PCT/JP2024/042685, filed on Dec. 3, 2024.

(30) Foreign Application Priority Data
Mar. 26, 2024 (JP) 2024-049771

(51) Int. Cl. G07G 1/00

(52) U.S. Cl. CPC G07G 1/0036

(57) ABSTRACT

A gate apparatus of an embodiment includes a notification unit, a reader, a confirmation unit, and a controller. The notification unit issues a notification indicating that passage of a customer is permitted. The reader reads an optically readable code. The confirmation unit confirms, based on the code read by the reader, whether or not settlement has been completed. The controller controls, in response to the code being read by the reader, the notification unit controls the notification unit to issue the notification in a case where the confirmation unit confirms that the settlement has been completed. The controller controls the notification unit to not issue the notification in a case where a settlement apparatus that has performed settlement processing related to a transaction identified by the code read by the reader is excluded from exit control.

### CROSS REFERENCE TO RELATED APPLICATIONS

This application is a Continuation Application of PCT Application No. PCT/JP2024/042685, filed Dec. 3, 2024 and based upon and claiming the benefit of priority from Japanese Patent Application No. 2024-049771, filed Mar. 26, 2024, the entire contents of all of which are incorporated herein by reference.

### FIELD

Embodiments described herein relate generally to a gate apparatus, a program recording medium, and a checkout system.

### BACKGROUND

In a store that handles transactions such as buying and selling of goods through to settlement, it is desirable that customers who have completed settlement be properly guided to exit the store.

### BRIEF DESCRIPTION OF THE DRAWINGS

FIG. 1 is a view of an overall configuration of a commodity sale system according to an embodiment.

FIG. 2 is a schematic diagram showing an example of a layout of a checkout corner of a store that incorporates a commodity sale system.

FIG. 3 is a block diagram showing a circuit configuration of the main parts of the transaction processing apparatus shown in FIG. 1.

FIG. 4 is a block diagram showing a circuit configuration of the main parts of the POS terminal shown in FIG. 1.

FIG. 5 is a block diagram showing a circuit configuration of the main parts of the POS terminal shown in FIG. 1.

FIG. 6 is a block diagram showing a circuit configuration of the main parts of the checkout gate shown in FIG. 1.

FIG. 7 is a perspective view of an exterior of the checkout gate shown in FIG. 1.

FIG. 8 is a block diagram showing a circuit configuration of the main parts of the information processing terminal shown in FIG. 1.

FIG. 9 is a block diagram showing a circuit configuration of the main parts of the monitoring terminal shown in FIG. 1.

FIG. 10 is a block diagram showing a circuit configuration of the main parts of the POS server shown in FIG. 1.

FIG. 11 is a sequence diagram relating to transaction processing using the information processing terminal shown in FIG. 1.

FIG. 12 is a flowchart of gate control processing

FIG. 13 is a flowchart of gate control processing.

FIG. 14 is a flowchart of gate control processing.

FIG. 15 is a screen showing an example of a standby screen displayed on the touch panel shown in FIG. 6.

FIG. 16 is a diagram showing an example of a standby screen displayed on the display unit shown in FIG. 6.

FIG. 17 is a flowchart of passage permission processing.

FIG. 18 is a diagram showing an example of a first guidance screen.

FIG. 19 is a diagram showing an example of a second guidance screen.

FIG. 20 is a sequence diagram relating to transaction processing using the POS terminal shown in FIG. 1.

FIG. 21 is a sequence diagram relating to transaction processing using the POS terminal shown in FIG. 1.

FIG. 22 is a flowchart of transaction search processing.

FIG. 23 is a diagram showing an example of an addition-request screen.

FIG. 24 is a flowchart of clerk calling processing performed by the processor shown in FIG. 6 and issuance processing performed by the processor shown in FIG. 9.

FIG. 25 is a diagram showing an example of a call-in progress screen.

FIG. 26 is a diagram showing an example of a warning screen.

FIG. 27 is a flowchart of exit confirmation processing.

FIG. 28 is a flowchart of erroneous-passage processing performed by the processor shown in FIG. 6 and alarm processing performed by the processor shown in FIG. 9.

FIG. 29 is a diagram showing an example of a first warning screen.

FIG. 30 is a diagram showing a modification of the gate control processing.

FIG. 31 is a diagram showing an example of a standby screen adapted to the modification.

### DETAILED DESCRIPTION

A gate apparatus of an embodiment includes a notification unit, a reader, a confirmation unit, and a controller. The notification unit issues a notification indicating that passage of a customer is permitted. The reader reads an optically readable code. The confirmation unit confirms whether or not settlement has been completed based on the code read by the reader. The controller controls the notification unit to issue a notification in a case where the confirmation unit confirms that settlement has been completed in response to the code being read by the reader. Further, the controller controls the notification unit to not issue a notification in a case where a settlement apparatus that has performed processing for settlement of a transaction identified by the code read by the reader is excluded from exit control.

Hereinafter, a commodity sale system that performs processing related to the sale of commodities to customers in a store will be described with reference to the drawings. The commodity sale system is also an example of a transaction processing system that processes the sale of commodities as a target transaction. The transactions to be processed may be different types of transactions from the sale of commodities, such as provision of any service in a store. In any case, it is assumed that customers are permitted to exit a store after settlement of a transaction to be processed is completed.

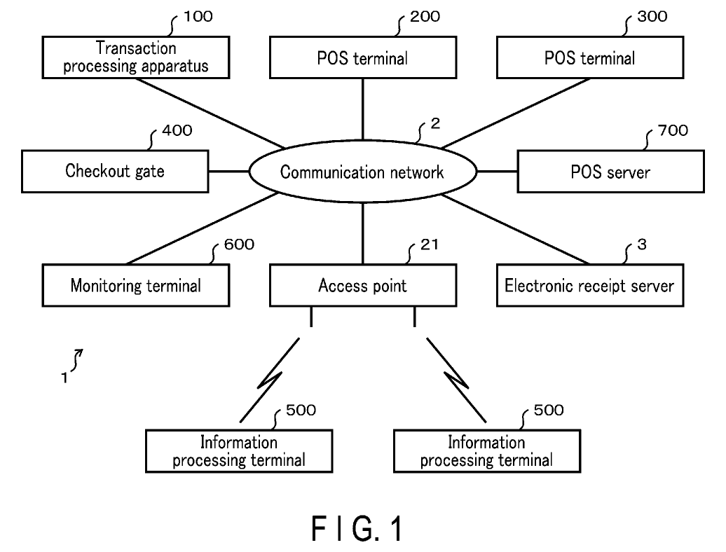

FIG. 1 is a view of an overall configuration of a commodity sale system 1 according to the present embodiment.

The commodity sale system 1 includes a transaction processing apparatus 100, point-of-sale (POS) terminals 200 and 300, a checkout gate 400, an information processing terminal 500, a monitoring terminal 600, and a POS server 700. The commodity sale system 1 is configured to be able to communicate with the transaction processing apparatus 100, the POS terminal 200, the checkout gate 400, the information processing terminal 500, the monitoring terminal 600, and the POS server 700 via a communication network 2. The POS terminal 200 and the checkout gate 400 can also communicate with an electronic receipt server 3 via the communication network 2. The electronic receipt server 3 provides an electronic receipt service that enables an electronic receipt screen showing the content of a transaction processed by the commodity sale system 1 to be viewed on any information terminal.

FIG. 1 shows one POS terminal 200, one POS terminal 300, one information processing terminal 500, one monitoring terminal 600, one POS server 700, and three checkout gates 400; however, the number of these components is discretionary. One or two of the POS terminal 200, the POS terminal 300, and the information processing terminal 500 may be provided, and the remaining two or one of them may not be provided. In many cases, the commodity sale system 1 includes a plurality of POS terminals 200, a plurality of POS terminals 300, and a plurality of information processing terminals 500 in a case where they are arranged in the commodity sale system 1.

The communication network 2 may be the Internet, a virtual private network (VPN), a local area network (LAN), a public communication network, a mobile communication network, or the like, which may be used alone or in suitable combination. For example, a LAN, the Internet, and a mobile communication network are used in combination as the communication network 2. For example, a LAN is used for communication between the transaction processing apparatus 100, the POS terminal 200, the checkout gate 400, the information processing terminal 500, the monitoring terminal 600, and the POS server 700. For example, a LAN is used for communication between the transaction processing apparatus 100 and the information processing terminal 500. However, the information processing terminal 500 is connected to the communication network 2 by wireless access via an access point 21 included in the communication network 2. For example, a LAN and the Internet are used for communication between the POS terminal 200 or the checkout gate 400 and the electronic receipt server 3.

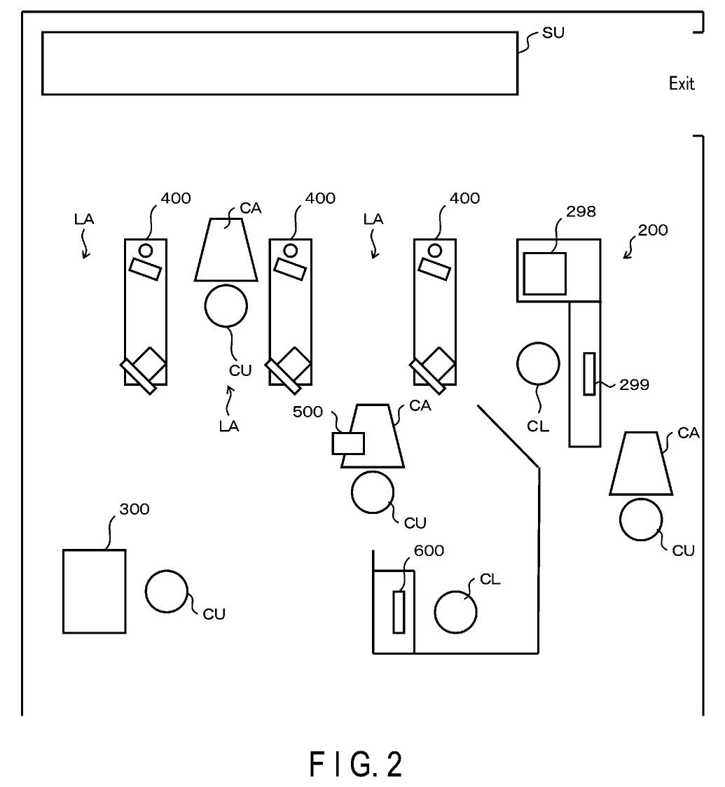

FIG. 2 is a schematic diagram showing an example of a layout of a checkout corner of a store that incorporates the commodity sale system 1.

The information processing terminal 500 is temporarily operated by a customer CU who shops in a store. The information processing terminal 500 is attached to, for example, a shopping cart (hereinafter, simply referred to as a “cart”) CA. The information processing terminal 500 may be carried by a customer CU. For example, an existing portable information processing apparatus such as a tablet computer, a smartphone, or a smartwatch can be used as the information processing terminal 500. The information processing terminal 500 may be installed in a store and temporarily used by a customer CU, or may be owned by a customer CU. A customer CU goes around a sales floor while pushing a cart CA, and directly places a commodity to be purchased on a cart CA or puts a commodity in a basket on a cart CA. At this time, the customer CU operates the information processing terminal 500 to perform an operation for registering a commodity on a cart CA as a transaction commodity. The transaction processing apparatus 100 registers a transaction commodity in accordance with an operation performed at the information processing terminal 500. The information processing terminal 500 may be operated by a clerk CL instead of a customer CU. Once the customer CU has selected all the commodities to be purchased, the customer CU goes to a checkout corner and performs checkout using the checkout gate 400. Thereafter, the customer CU passes through a checkout lane LA facing the checkout gate 400 used for the checkout and then exits the store. In a case where a plurality of checkout gates 400 are installed as shown in FIG. 2, the plurality of checkout gates 400 are installed in a state of facing each of a plurality of checkout lanes LA. The checkout gate 400 also has an exit gate function for controlling the passage of a customer CU in the checkout lane LA facing the checkout gate 400, and is an example of a gate apparatus. The exit gate function will be described later. After passing through the checkout lane LA, the customer CU bags the commodities at a sacker table SU as necessary. Thus, the commodity sale system 1 is also a checkout system for the checkout in a store.

A customer CU may leave the registration of a commodity to be purchased as a transaction commodity to a clerk CL who operates the POS terminal 200 without using the information processing terminal 500. A clerk CL operates the POS terminal 200 to register a commodity brought by a customer CU as a transaction commodity and handles the payment. That is, the POS terminal 200 is a so-called face-to-face terminal. The operation of the POS terminal 200 may be the same as that of an existing POS terminal of the same type. In FIG. 2, the POS terminal 200 is an example of a separate-type terminal and is separated into a main body unit 298 and a scanner unit 299. The POS terminal 200 may have a different configuration form such as an integrated type. The POS terminal 200 may be a semi-self-service-type terminal formed of a registration terminal operated by a clerk CL and a checkout terminal operated by a customer CU. A customer CU who completes the checkout at the POS terminal 200 exits the store without passing through the checkout lane LA.

A customer CU can also perform the registration of a commodity to be purchased as a transaction commodity and the checkout by operating the POS terminal 300 by him/herself without using the information processing terminal 500. That is, the POS terminal 300 is a so-called full-self-service-type terminal. The operation of the POS terminal 300 may be the same as that of an existing POS terminal of the same type. A customer CU who completes the checkout at the POS terminal 300 passes through the checkout lane LA and exits the store.

The monitoring terminal 600 supports a clerk CL who monitors for unauthorized passage through the checkout lane LA. The POS server 700 manages a transaction processed by the commodity sale system 1.

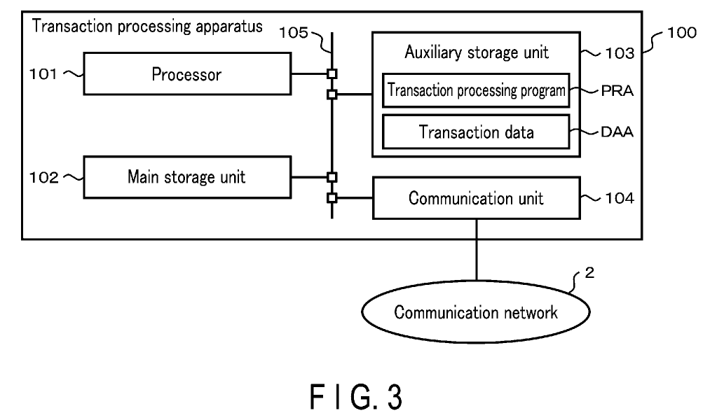

FIG. 3 is a block diagram showing a circuit configuration of the main parts of the transaction processing apparatus 100.

The transaction processing apparatus 100 includes a processor 101, a main storage unit 102, an auxiliary storage unit 103, a communication unit 104, a transmission path 105, and the like. The processor 101 is capable of communicating with the main storage unit 102, the auxiliary storage unit 103, and the communication unit 104 via the transmission path 105.

The processor 101, the main storage unit 102, and the auxiliary storage unit 103 are connected to each other through the transmission path 105, thereby forming a computer that performs information processing for controlling the transaction processing apparatus 100.

The processor 101 corresponds to a central part of the computer. The processor 101 performs information processing for controlling each unit in order to implement various functions of the transaction processing apparatus 100 in accordance with an operating system and an information processing program such as an application program. The processor 101 is, for example, processing circuitry configured by one or more circuits such as a central processing unit (CPU), a graphics processing unit (GPU), an application specific integrated circuit (ASIC), a programmable logic device (e.g., a simple programmable logic device (SPLD), a complex programmable logic device (CPLD), or a field programmable gate array (FPGA)), etc.

The main storage unit 102 corresponds to a main storage part of the computer. The main storage unit 102 includes a read-only memory area and a rewritable memory area. The main storage unit 102 stores a part of the above-mentioned information processing program in the read-only memory area. The main storage unit 102 may store data necessary for the processor 101 to execute processing for controlling each unit in the read-only memory area or rewritable memory area. The main storage unit 102 uses the rewritable memory area as a work area for the processor 101.

The auxiliary storage unit 103 corresponds to an auxiliary storage part of the computer. For example, an electric erasable programmable read-only memory (EEPROM), a hard disk drive (HDD), a solid-state drive (SSD), or other various known storage devices can be used as the auxiliary storage unit 103. The auxiliary storage unit 103 stores data for use by the processor 101 to perform various types of processing and data generated by the processing at the processor 101. The auxiliary storage unit 103 may store the above-mentioned information processing program. In the present embodiment, the auxiliary storage unit 103 stores a transaction processing program PRA, which is an information processing program. The transaction processing program PRA is an application program in which a procedure of transaction processing described later is written. A part of the storage area of the auxiliary storage unit 103 is used as an area for storing transaction data DAA. The transaction data DAA is data representing the content of a transaction.

The communication unit 104 performs communication processing for performing data communication via the communication network 2. For example, an existing wired communication device for the Internet can be used as the communication unit 104. As the communication unit 104, a wireless communication device connected to the communication network 2 via wireless communication may be used instead of or in addition to the wired communication device.

The transmission path 105 includes an address bus, a data bus, a control signal line, and the like, and transmits data and a control signal transmitted and received between the connected units.

For example, a general-purpose server device can be used as basic hardware of the transaction processing apparatus 100. The transaction processing apparatus 100 is generally transferred in a state where the transaction processing program PRA is stored in the auxiliary storage unit 103. However, hardware in a state where the transaction processing program PRA is not stored in the auxiliary storage unit 103 or in a state where another version of the same type of application program is stored in the auxiliary storage unit 103, and the transaction processing program PRA may be transferred individually. The transaction processing apparatus 100 may be configured by the transaction processing program PRA being written to the auxiliary storage unit 103 in accordance with an operation by any operator. The transaction processing program PRA can be transferred by being recorded in a removable recording medium such as a magnetic disk, a magneto-optical disk, an optical disk, or a semiconductor memory, or through communication via a network. The transaction processing program PRA may be stored in the main storage unit 102.

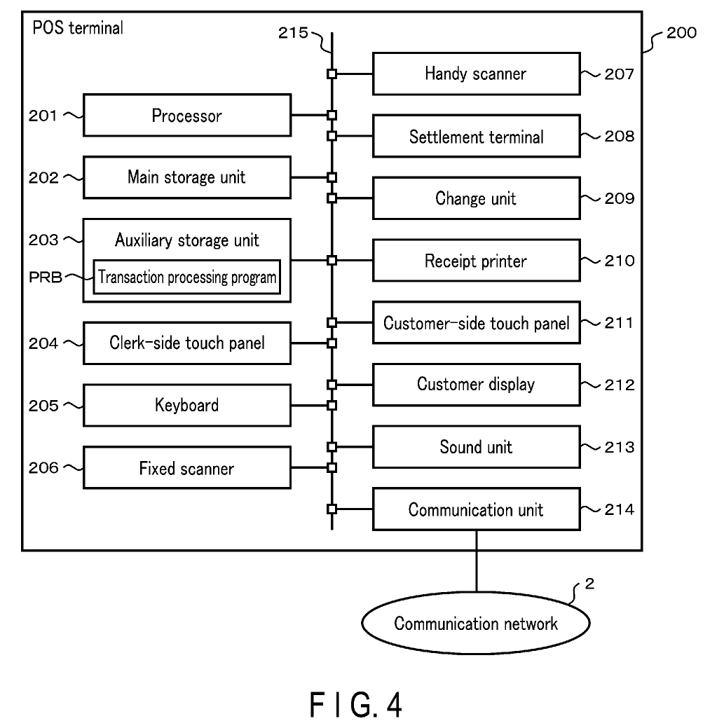

FIG. 4 is a block diagram showing a circuit configuration of the main parts of the POS terminal 200.

The POS terminal 200 includes a processor 201, a main storage unit 202, an auxiliary storage unit 203, a clerk-side touch panel 204, a keyboard 205, a fixed scanner 206, a handy scanner 207, a settlement terminal 208, a change unit 209, a receipt printer 210, a customer-side touch panel 211, a customer display 212, a sound unit 213, a communication unit 214, and a transmission path 215. As one example, the processor 201, the main storage unit 202, the auxiliary storage unit 203, the clerk-side touch panel 204, the keyboard 205, the change unit 209, the receipt printer 210, and the communication unit 214 are provided in the main body unit 298. As another example, the fixed scanner 206, the handy scanner 207, the settlement terminal 208, the customer-side touch panel 211, the customer display 212, and the sound unit 213 are provided in the scanner unit 299. However, the units in which the aforementioned components are described as being provided in the foregoing may be reversed for some of the components. Some of the components such as the touch panel for clerks and the keyboard may be provided in both the main body unit 298 and the scanner unit 299.

The outline of the functions of the processor 201, the main storage unit 202, the auxiliary storage unit 203, the communication unit 214, and the transmission path 215 is equivalent to that of the processor 101, the main storage unit 102, the auxiliary storage unit 103, the communication unit 104, and the transmission path 105.

However, the auxiliary storage unit 203 stores a transaction processing program PRB instead of the transaction processing program PRA. The transaction processing program PRB is an application program describing a procedure of information processing by the processor 201 for transaction processing corresponding to an operation performed by a clerk with a device provided to the POS terminal 200.

The clerk-side touch panel 204 is arranged to face a side where a clerk CL who operates the POS terminal 200 stands (hereinafter, referred to as a “clerk side”). The clerk-side touch panel 204 displays a screen for presenting information to a clerk CL. An instruction through a touch operation on the screen by a clerk CL is input through the clerk-side touch panel 204.

The keyboard 205 includes many hard keys so that a clerk CL can easily perform an operation from the clerk side. An instruction by a clerk CL through pressing of these hard keys is input through the keyboard 205.

The fixed scanner 206 has a reading window facing the clerk side. The fixed scanner 206 captures an image of a commodity held in front of the reading window and then recognizes, through image processing, barcode information represented by a barcode formed on the commodity. The fixed scanner 206 then outputs the barcode information to the processor 201. The fixed scanner 206 may be another type of known device that optically reads a barcode using reflection of laser light. The fixed scanner 206 may be a type of known device having a function of identifying, by using an object recognition technique, a commodity from an image of the commodity itself obtained by capturing an image of the commodity.

The handy scanner 207 is used by being held by a hand of a clerk CL and optically reads a barcode facing a reading port. The handy scanner 207 outputs barcode information represented by the read barcode to the processor 201.

The settlement terminal 208 reads data recorded in a payment card such as a credit card, a prepaid card, or an electronic money card. The settlement terminal 208 writes data to a payment card. The settlement terminal 208 includes reading devices respectively corresponding to IC reading, magnetic reading, and proximity communication reading of a credit card. The reading device for IC reading reads data stored in an integrated circuit (IC) provided in a credit card through communication via an electrical contact. The reading device for magnetic reading reads data magnetically recorded on a magnetic stripe formed on the surface of a credit card using a magnetic head. Thus, both IC reading and magnetic reading involve contact between the settlement terminal 208 and a credit card, and are examples of contact reading. Both the reading device for IC reading and the reading device for magnetic reading are examples of a contact reading device. The reading device for proximity communication reading reads data stored in an integrated circuit (IC) provided in a credit card through wireless communication such as near field communication (NFC). Thus, proximity communication reading is an example of contactless reading. The reading device for proximity communication reading is an example of a contactless reading device.

The change unit 209 stores coins inserted from a coin insertion slot in an internal storage while counting the amount of the coins inserted. The change unit 209 discharges coins stored in the storage to a coin tray via a coin discharge port. The change unit 209 stores bills inserted from a bill insertion slot in an internal storage while counting the amount of the bills inserted. The change unit 209 discharges bills stored in the storage from a bill discharge port. The bill discharge port holds the discharged bills with a part of the bills exposed to the outside.

The receipt printer 210 prints an image of a voucher such as a sales receipt, an official receipt, or a sales slip on a receipt sheet. The receipt printer 210 discharges a receipt sheet with the image printed thereon from a receipt discharge port to the outside. Hereinafter, a receipt sheet with an image of a receipt printed thereon is referred to as a “paper receipt.”

The customer-side touch panel 211 is arranged to face a side where a customer CU stands when the registration of a transaction commodity is performed through an operation by a clerk CL (hereinafter, referred to as a “customer side”). The customer-side touch panel 211 displays a screen for presenting information to a customer. An instruction through a touch operation on the screen by a customer CU is input through the customer-side touch panel 211.

The customer display 212 is arranged to face the customer side. The customer display 212 displays a screen for presenting information to a customer CU. The customer display 212 is adapted mainly to display a character string, and displays a screen that is simpler than one displayed by the customer-side touch panel 211.

The sound unit 213 outputs sounds and voices for various types of guidance and alarm. As the sound unit, various known sound devices such as a voice synthesis device and a buzzer can be used alone or in combination.

For example, hardware of a different existing POS terminal can be used as the basic hardware of the POS terminal 200. At this time, the POS terminal 200 is generally transferred in a state where the transaction processing program PRB is stored in the auxiliary storage unit 203. However, the hardware of the POS terminal 200 in a state where the transaction processing program PRB is not stored in the auxiliary storage unit 203, and the transaction processing program PRB may be transferred individually. The transaction processing program PRB may be written to the auxiliary storage unit 203 in accordance with an operation by any operator. Alternatively, the hardware of the POS terminal 200 in a state where another version of the same type of information processing program as the transaction processing program PRB is stored in the auxiliary storage unit 203, and the transaction processing program PRB may be transferred individually. The transaction processing program PRB may be written to the auxiliary storage unit 203 in a form of replacing the information processing program already stored in the auxiliary storage unit 203. The transaction processing program PRB can be transferred by being recorded in a removable recording medium such as a magnetic disk, a magneto-optical disk, an optical disk, or a semiconductor memory, or by communication via a network. The transaction processing program PRB may be stored in the main storage unit 202.

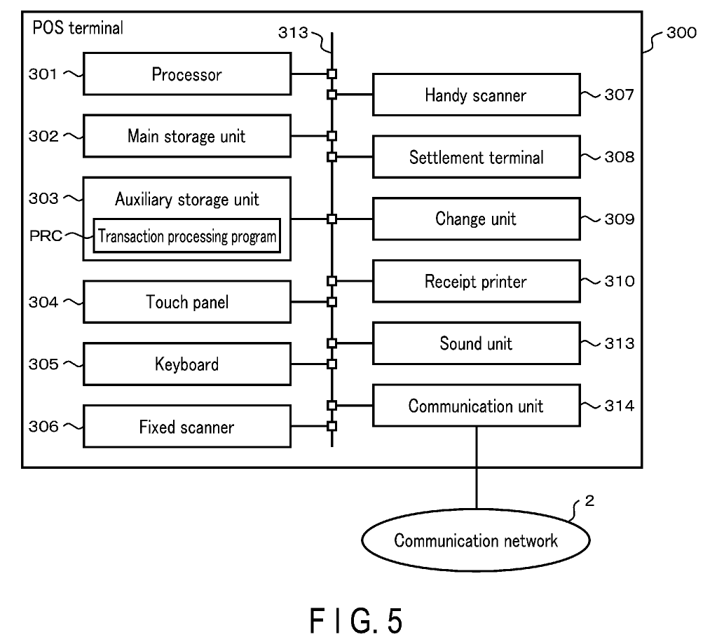

FIG. 5 is a block diagram showing a circuit configuration of the main parts of the POS terminal 300.

The POS terminal 300 includes a processor 301, a main storage unit 302, an auxiliary storage unit 303, a touch panel 304, a keyboard 305, a fixed scanner 306, a handy scanner 307, a settlement terminal 308, a change unit 309, a receipt printer 310, a sound unit 311, a communication unit 312, and a transmission path 313.

The outline of the functions of the processor 301, the main storage unit 302, the auxiliary storage unit 303, the communication unit 312, and the transmission path 313 is equivalent to that of the processor 101, the main storage unit 102, the auxiliary storage unit 103, the communication unit 104, and the transmission path 105.

However, the auxiliary storage unit 303 stores a transaction processing program PRC instead of the transaction processing program PRA. The transaction processing program PRC is an application program describing a procedure of information processing by the processor 301 for transaction processing corresponding to an operation performed by a customer with a device provided to the POS terminal 300.

The touch panel 304 is arranged to face a side where a customer CU who operates the POS terminal 300 stands. The touch panel 304 displays a screen for presenting information to a customer CU. An instruction through a touch operation on the screen by a customer CU is input through the touch panel 304.

The outline of the functions of the keyboard 305, the fixed scanner 306, the handy scanner 307, the settlement terminal 308, the change unit 309, the receipt printer 310, and the sound unit 311 is equivalent to that of the keyboard 205, the fixed scanner 206, the handy scanner 207, the settlement terminal 208, the change unit 209, the receipt printer 210, and the sound unit 213. However, the keyboard 305, the fixed scanner 306, the handy scanner 307, and the settlement terminal 308 are provided so as to make an operation by a customer CU easy, and are operated mainly by a customer CU.

For example, hardware of a different existing full-self-service-type POS terminal can be used as the basic hardware of the POS terminal 300. At this time, the POS terminal 300 is generally transferred in a state where the transaction processing program PRC is stored in the auxiliary storage unit 303. However, the hardware of the POS terminal 300 in a state where the transaction processing program PRC is not stored in the auxiliary storage unit 303, and the transaction processing program PRC may be transferred individually. The transaction processing program PRC may be written to the auxiliary storage unit 303 in accordance with an operation by any operator. Alternatively, the hardware of the POS terminal 300 in a state where another version of the same type of information processing program as the transaction processing program PRC is stored in the auxiliary storage unit 303, and the transaction processing program PRC may be transferred individually. The transaction processing program PRC may be written to the auxiliary storage unit 303 in a form of replacing the information processing program already stored in the auxiliary storage unit 303. The transaction processing program PRC can be transferred by being recorded in a removable recording medium such as a magnetic disk, a magneto-optical disk, an optical disk, or a semiconductor memory, or by communication via a network. The transaction processing program PRC may be stored in the main storage unit 302.

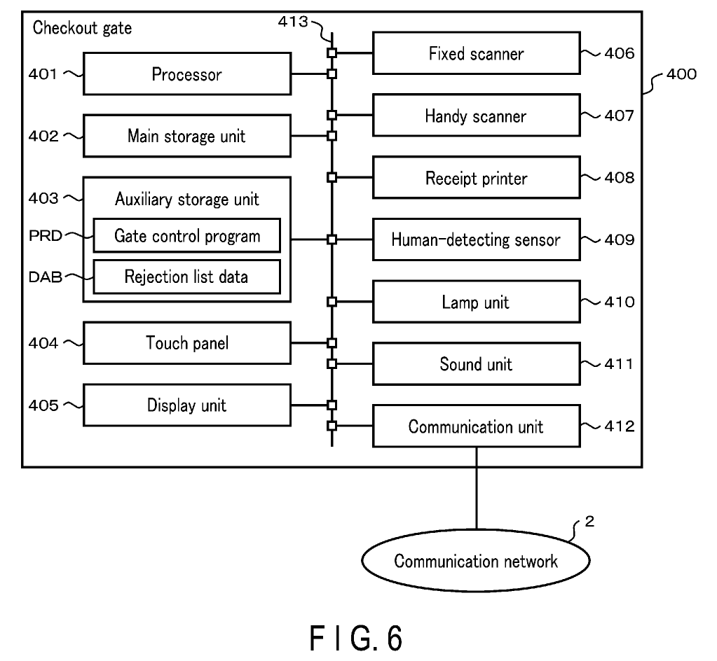

FIG. 6 is a block diagram showing a circuit configuration of the main parts of the checkout gate 400.

The checkout gate 400 includes a processor 401, a main storage unit 402, an auxiliary storage unit 403, a touch panel 404, a display unit 405, a fixed scanner 406, a handy scanner 407, a receipt printer 408, a human-detecting sensor 409, a lamp unit 410, a sound unit 411, a communication unit 412, and a transmission path 413.

The outline of the functions of the processor 401, the main storage unit 402, the auxiliary storage unit 403, the communication unit 412, and the transmission path 413 is equivalent to that of the processor 101, the main storage unit 102, the auxiliary storage unit 103, the communication unit 104, and the transmission path 105.

However, the auxiliary storage unit 403 stores a gate control program PRD instead of the transaction processing program PRA. The gate control program PRD is an application program describing a procedure of information processing by the processor 401 for gate control processing described later. The auxiliary storage unit 403 stores rejection list data DAB. The rejection list data DAB represents a list of POS terminals predetermined as targets to be rejected. Which of the POS terminals, the POS terminal 200 or the POS terminal 300, is to be rejected may be suitably determined by an arbitrary setting entity such as an administrator of the commodity sale system 1. In the present embodiment, the POS terminal 200 is a target for rejection.

The touch panel 404 displays a screen for presenting information to an operator who performs a checkout operation. An instruction through a touch operation on the screen by an operator is input through the touch panel 404. An operator of the checkout gate 400 is usually a customer CU. However, a clerk CL may be an operator of the checkout gate 400.

The display unit 405 displays a screen for presenting information to a customer CU who is about to pass through the checkout lane LA facing the checkout gate 400 provided with the display unit 405. Hereinafter, simply indicating "checkout lane LA" in connection with the description of the checkout gate 400 refers to a checkout lane LA facing the relevant checkout gate 400.

The fixed scanner 406 has a reading window. The fixed scanner 406 recognizes, through image processing, barcode information represented by a barcode held in front of the reading window. The fixed scanner 406 then outputs the barcode information to the processor 401. The fixed scanner 406 may be another type of known device that optically reads a barcode using reflection of laser light. The fixed scanner 406 may be a type of known device having a function of identifying, by using an object recognition technique, a commodity from an image of the commodity itself obtained by capturing an image of the commodity.

The handy scanner 407 is used by being held by a hand of a customer CU and optically reads a barcode facing a reading port. The handy scanner 407 outputs barcode information represented by the read barcode to the processor 401.

The receipt printer 408 prints an image of a voucher such as a sales receipt, an official receipt, or a sales slip on a receipt sheet. The receipt printer 408 discharges a receipt sheet with the image printed thereon from a receipt discharge port to the outside. That is, the receipt printer 408 is used to issue a paper receipt.

The human-detecting sensor 409 detects a customer CU passing through the checkout lane LA. As the human-detecting sensor 409, a known detection device such as an optical sensor or an infrared sensor can be used as appropriate. That is, the human-detecting sensor 409 is an example of a first detector.

The lamp unit 410 displays a permission status of a customer CU passing through the checkout lane LA.

The sound unit 411 outputs sounds and voices for various types of guidance and alarms related to a customer CU passing through the checkout lane LA. As the sound unit, various known sound devices such as a voice synthesis device and a buzzer can be used alone or in combination.

The checkout gate 400 is generally transferred in a state where the gate control program PRD is stored in the auxiliary storage unit 403. However, hardware in a state where the gate control program PRD is not stored in the auxiliary storage unit 403 or in a state where another version of the same type of application program is stored in the auxiliary storage unit 403, and the gate control program PRD may be transferred individually. The checkout gate 400 may be configured by the gate control program PRD being written to the auxiliary storage unit 403 in accordance with an operation by any operator. The gate control program PRD can be transferred by being recorded in a removable recording medium such as a magnetic disk, a magneto-optical disk, an optical disk, or a semiconductor memory, or by communication via a network. The gate control program PRD may be stored in the main storage unit 402.

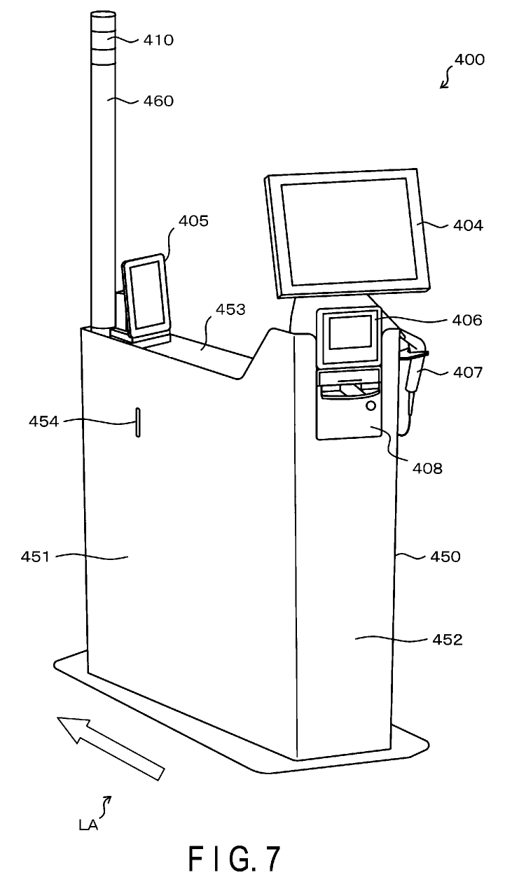

FIG. 7 is a perspective view of an exterior of the checkout gate 400.

In FIG. 7, the same elements as those shown in FIG. 6 are denoted by the same reference numerals. In the following description relating to FIG. 7, the left and right sides in FIG. 7 are referred to as the front and rear sides, respectively.

The checkout gate 400 includes a housing 450 having a substantially rectangular parallelepiped shape. The checkout gate 400 is installed with one side surface 451 of the housing 450 facing the checkout lane LA in order to control the movement of a customer CU through the checkout lane LA in a movement direction indicated by the arrow AR. A side surface of the housing 450 anterior to the movement direction of a customer CU is hereinafter referred to as a “front surface 452.”

The housing 450 holds the fixed scanner 406 in a posture in which a barcode held over from the front surface 452 side is read. The housing 450 holds the display unit 405 near an end of an upper surface 453 on the side opposite to the front surface 452 in a posture in which the display surface is easily viewed from a customer CU who is about to pass through the checkout lane LA. The housing 450 holds the receipt printer 408 below the fixed scanner 406 in a posture in which a receipt is discharged to the front surface 452 side.

The touch panel 404 is attached above the fixed scanner 406 in a posture in which the display surface is easily viewed from a customer CU facing the front surface 452. The handy scanner 407 is connected to the transmission path 413 inside the housing 450 via a cable, and can be pulled toward the front of the front surface 452 for use. In FIG. 7, the handy scanner 407 is set in a holder. The human-detecting sensor 409 is arranged inside the housing 450 so as to detect a customer CU passing through the checkout lane LA through a slit 454 formed in the side surface 451. The lamp unit 410 is attached to a distal end of a pole 460 erected on the upper surface 453 of the housing 450.

The processor 401, the main storage unit 402, the auxiliary storage unit 403, the sound unit 411, and the communication unit 412 shown in FIG. 6 are arranged inside the housing 450.

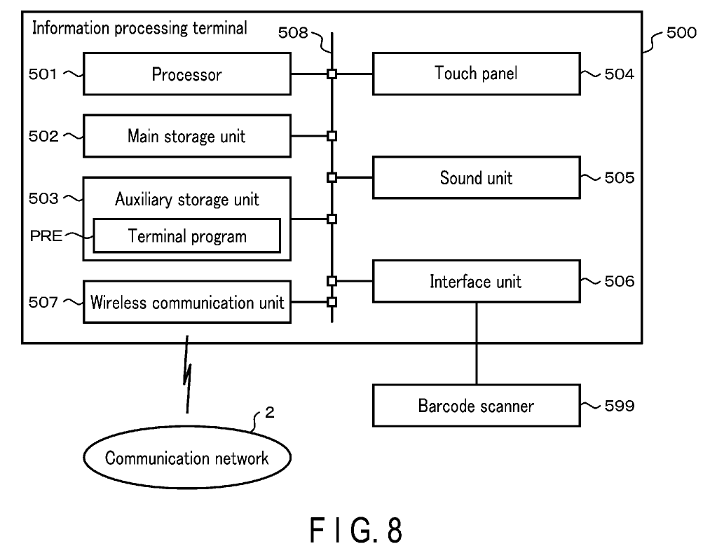

FIG. 8 is a block diagram showing a circuit configuration of the main parts of the information processing terminal 500.

The information processing terminal 500 includes a processor 501, a main storage unit 502, an auxiliary storage unit 503, a touch panel 504, a sound unit 505, an interface unit 506, a wireless communication unit 507, a transmission path 508, and the like.

The outline of the functions of the processor 501, the main storage unit 502, the auxiliary storage unit 503, and the transmission path 508 is equivalent to that of the processor 101, the main storage unit 102, the auxiliary storage unit 103, the communication unit 104, and the transmission path 105.

However, the auxiliary storage unit 503 stores a terminal program PRE instead of the transaction processing program PRA. The terminal program PRE is an application program describing a procedure of information processing by the processor 501 for causing the information processing terminal 500 to function as a user interface for registering a transaction commodity in the transaction processing apparatus 100.

The touch panel 504 displays a screen for presenting information to an operator. An instruction through a touch operation on the screen by an operator is input through the touch panel 504. An operator of the information processing terminal 500 is usually a customer CU. However, a clerk CL may be an operator of the information processing terminal 500.

The sound unit 505 outputs sounds and voices for various types of guidance and alarms. As the sound unit, various known sound devices such as a voice synthesis device and a buzzer can be used alone or in combination.

An external device such as a barcode scanner 599 is connected to the interface unit 506. The interface unit 506 interfaces data transmission and reception with a connected external device. As the interface unit 506, an existing universal serial bus (USB) controller or the like can be used. The barcode scanner 599 is attached to the cart CA and has a reading window. The barcode scanner 599 recognizes, through image processing, barcode information represented by a barcode held in front of the reading window. The barcode scanner 599 outputs the barcode information. The barcode scanner 599 may be another type of known device that optically reads a barcode using reflection of laser light. The barcode scanner 599 may be a type of known device having a function of identifying, by using an object recognition technique, a commodity from an image of the commodity itself obtained by capturing an image of the commodity. Instead of or in addition to the barcode scanner 599, a camera provided to the information processing terminal 500 may be used to read a barcode.

The wireless communication unit 507 performs communication processing for wirelessly performing data communication via the communication network 2. For example, an existing wireless communication device for a wireless LAN can be used as the wireless communication unit 507. A communication unit connected to the communication network 2 in a wired manner may be used instead of or in addition to the wireless communication unit 507.

For example, it is assumed that hardware of a tablet-type information processing apparatus is used as the basic hardware of the information processing terminal 500. The information processing terminal 500 is generally transferred in a state where the terminal program PRE is stored in the auxiliary storage unit 503. However, hardware in a state where the terminal program PRE is not stored in the auxiliary storage unit 503 or in a state where another version of the same type of application program is stored in the auxiliary storage unit 503, and the terminal program PRE may be transferred individually. The information processing terminal 500 may be configured by the terminal program PRE being written to the auxiliary storage unit 503 in accordance with an operation by any operator. The terminal program PRE can be transferred by being recorded in a removable recording medium such as a magnetic disk, a magneto-optical disk, an optical disk, or a semiconductor memory, or by communication via a network. The terminal program PRE may be stored in the main storage unit 502.

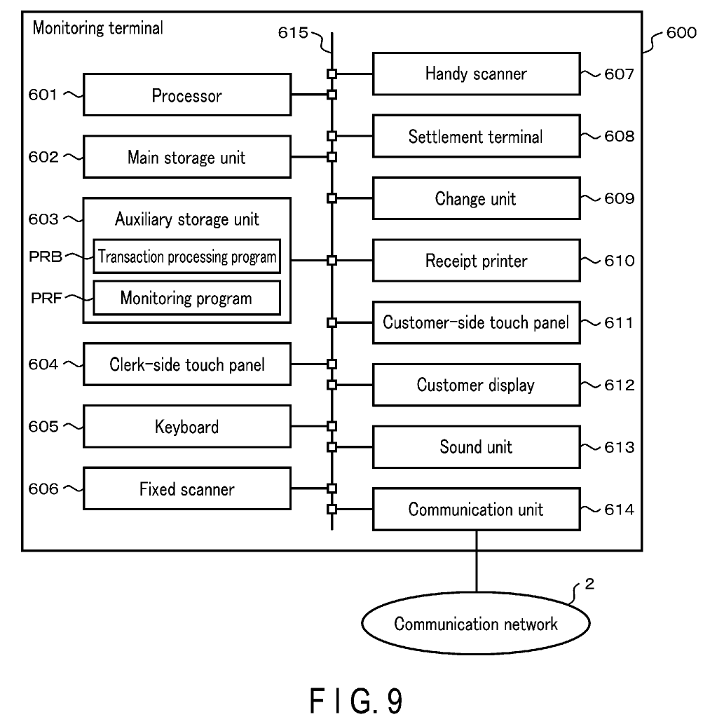

FIG. 9 is a block diagram showing a circuit configuration of the main parts of the monitoring terminal 600.

The monitoring terminal 600 includes a processor 601, a main storage unit 602, an auxiliary storage unit 603, a clerk-side touch panel 604, a keyboard 605, a fixed scanner 606, a handy scanner 607, a settlement terminal 608, a change unit 609, a receipt printer 610, a customer-side touch panel 611, a customer display 612, a sound unit 613, a communication unit 614, and a transmission path 615.

The outline of the functions of the processor 601, the main storage unit 602, the auxiliary storage unit 603, the sound unit 613, the communication unit 614, and the transmission path 615 is equivalent to that of the processor 101, the main storage unit 102, the auxiliary storage unit 103, the communication unit 104, and the transmission path 105. The functions of the clerk-side touch panel 604, the keyboard 605, the fixed scanner 606, the handy scanner 607, the settlement terminal 608, the change unit 609, the receipt printer 610, the customer-side touch panel 611, the customer display 612, and the sound unit 613 are equivalent to those of the clerk-side touch panel 204, the keyboard 205, the fixed scanner 206, the handy scanner 207, the settlement terminal 208, the change unit 209, the receipt printer 210, the customer-side touch panel 211, the customer display 212, and the sound unit 213. That is, the monitoring terminal 600 has the same hardware configuration as that of the POS terminal 200.

However, the auxiliary storage unit 603 stores a monitoring program PRF in addition to the transaction processing program PRB. The monitoring program PRF is an application program describing a procedure of information processing for supporting a clerk CL who monitors for unauthorized passage through the checkout lane LA. Thus, the monitoring terminal 600 is a device obtained by adding a monitoring support function to the POS terminal 200. However, the monitoring terminal 600 may be configured without the transaction processing function. In this case, general-purpose computer devices of various types such as a desktop type, a book type, and a tablet type can be used as the basic hardware of the monitoring terminal 600.

The monitoring terminal 600 is generally transferred in a state where the transaction processing program PRB and the monitoring program PRF are stored in the auxiliary storage unit 603. However, hardware in a state where at least one of the transaction processing program PRB or the monitoring program PRF is not stored in the auxiliary storage unit 603 or in a state where another version of the same type of application program is stored in the auxiliary storage unit 603, and at least one of the transaction processing program PRB or the monitoring program PRF may be transferred individually. The monitoring terminal 600 may be configured by the transaction processing program PRB and the monitoring program PRF being written to the auxiliary storage unit 603 in accordance with an operation by any operator. The transaction processing program PRB and the monitoring program PRF can be transferred by being recorded in a removable recording medium such as a magnetic disk, a magneto-optical disk, an optical disk, or a semiconductor memory, or by communication via a network. The transaction processing program PRB and the monitoring program PRF may be stored in the main storage unit 602.

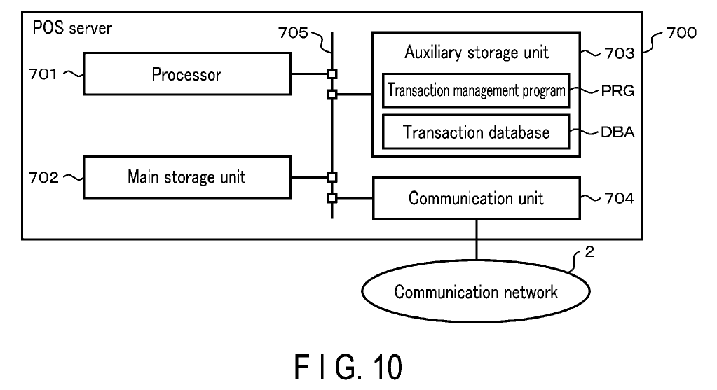

FIG. 10 is a block diagram showing a circuit configuration of the main parts of the POS server 700.

The POS server 700 includes a processor 701, a main storage unit 702, an auxiliary storage unit 703, a communication unit 704, and a transmission path 705.

The outline of the functions of the processor 701, the main storage unit 702, the auxiliary storage unit 703, the communication unit 704, and the transmission path 705 is equivalent to that of the processor 101, the main storage unit 102, the auxiliary storage unit 103, the communication unit 104, and the transmission path 105.

However, the auxiliary storage unit 703 stores a transaction management program PRG instead of the transaction processing program PRA. The transaction management program PRG is an application program describing a procedure of information processing by the processor 701 for managing transactions processed by the commodity sale system 1. A part of a storage area of the auxiliary storage unit 703 is used to store a transaction database DBA. The transaction database DBA is a database in which transaction data representing the content of each settled transaction is accumulated.

For example, a general-purpose server device can be used as basic hardware of the POS server 700. The POS server 700 is generally transferred in a state where the transaction management program PRG is stored in the auxiliary storage unit 703. However, hardware in a state where the transaction management program PRG is not stored in the auxiliary storage unit 703 or in a state where another version of the same type of application program is stored in the auxiliary storage unit 703, and the transaction management program PRG may be transferred individually. The POS server 700 may be configured by the transaction management program PRG being written to the auxiliary storage unit 703 in accordance with an operation by any operator. The transaction management program PRG can be transferred by being recorded in a removable recording medium such as a magnetic disk, a magneto-optical disk, an optical disk, or a semiconductor memory, or by communication via a network. The transaction management program PRG may be stored in the main storage unit 702.

Next, an operation of the commodity sale system 1 configured as described above will be described. The activities of various types of processing described below are merely examples, and, for example, the order of some types of processing may be changed, some types of processing may be omitted, or other types of processing may be added, as appropriate. For example, the following description omits description of some types of processing for the purpose of describing characteristic operations of the present embodiment in an easy-to-understand manner. For example, in a case where an error occurs, processing for handling the error may be performed; however, description of such processing is omitted.

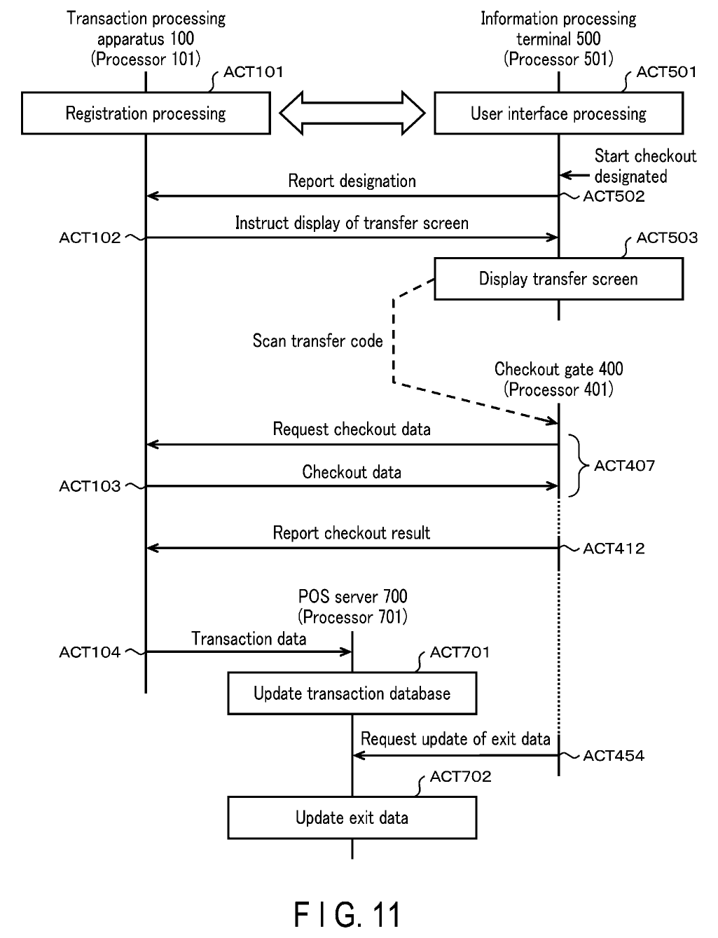

FIG. 11 is a sequence diagram relating to transaction processing using the information processing terminal 500.

In the transaction processing apparatus 100 and the information processing terminal 500, the processor 101 and the processor 501 perform registration processing as ACT 101 and user interface processing as ACT 501 in cooperation with each other. Accordingly, the processor 101 registers commodities to be purchased by a customer CU as transaction commodities while receiving an instruction from the customer CU using the information processing terminal 500 as a user interface terminal, and generates transaction data representing a list of transaction commodities. The registration processing is, for example, processing for causing the information processing terminal 500 to read a barcode of a commodity to be purchased by a customer CU or adding, as a transaction commodity, a commodity designated by a customer CU operating a preset key, which is a key set in advance, for designating a commodity displayed on the information processing terminal 500.

When a customer CU performs a predetermined operation for designating “Start Checkout” with the information processing terminal 500, the processor 501 in the information processing terminal 500 proceeds to ACT 502.

As ACT 502, the processor 501 notifies the transaction processing apparatus 100 that “Start Checkout” has been designated.

When a notification of the “Start Checkout” designation is issued, the processor 101 in the transaction processing apparatus 100 proceeds to ACT 102.

As ACT 102, the processor 101 instructs the information processing terminal 500 to display a transfer screen.

When an instruction to display a transfer screen is provided, the processor 501 in the information processing terminal 500 proceeds to ACT 503.

As ACT 503, the processor 501 causes the touch panel 504 to display a transfer screen. The transfer screen is a screen for transferring a function of a user interface terminal related to a transaction in process from the information processing terminal 500 to the checkout gate 400. The transfer screen includes, for example, a two-dimensional code (hereinafter, referred to as a “transfer code”) representing transfer data for the checkout gate 400 to request checkout data based on transaction data from the transaction processing device 100.

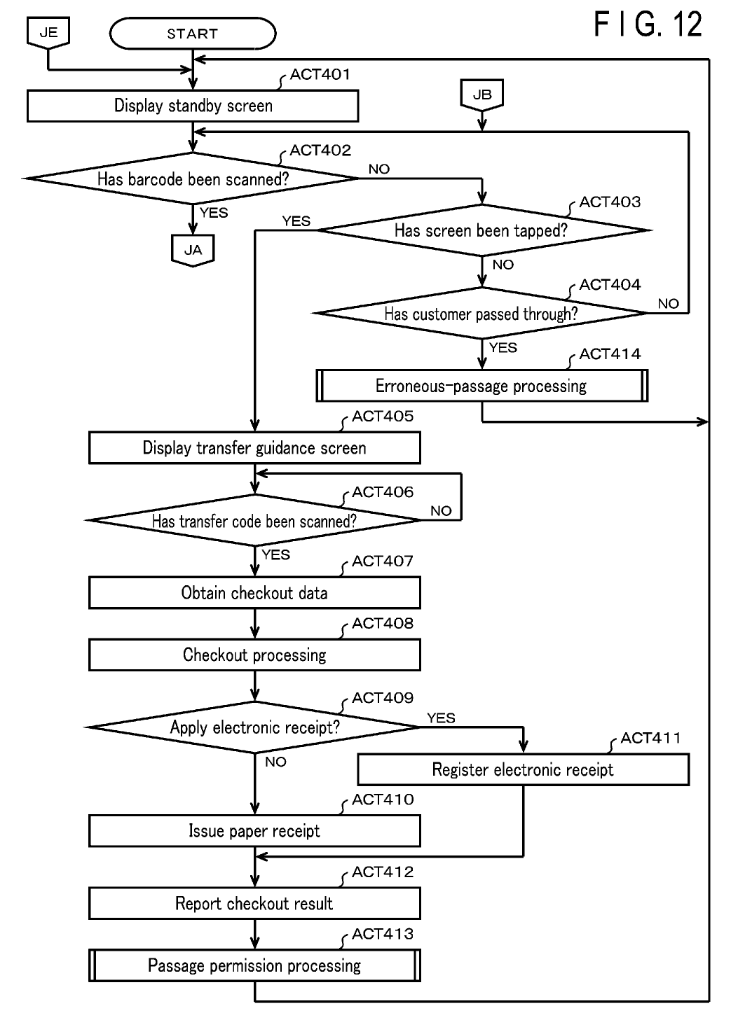

On the other hand, when the processor 401 in the checkout gate 400 is in an operational state that permits a customer CU to use it, the processor 401 performs gate control processing according to the gate control program PRD. FIGS. 12, 13 and 14, are flowcharts of the gate control processing.

As ACT 401, the processor 401 causes the touch panel 404 and the display unit 405 to display a standby screen. The standby screen is a screen for providing guidance for an operation that should be performed by a customer CU while waiting for an operation to be performed by a customer CU.

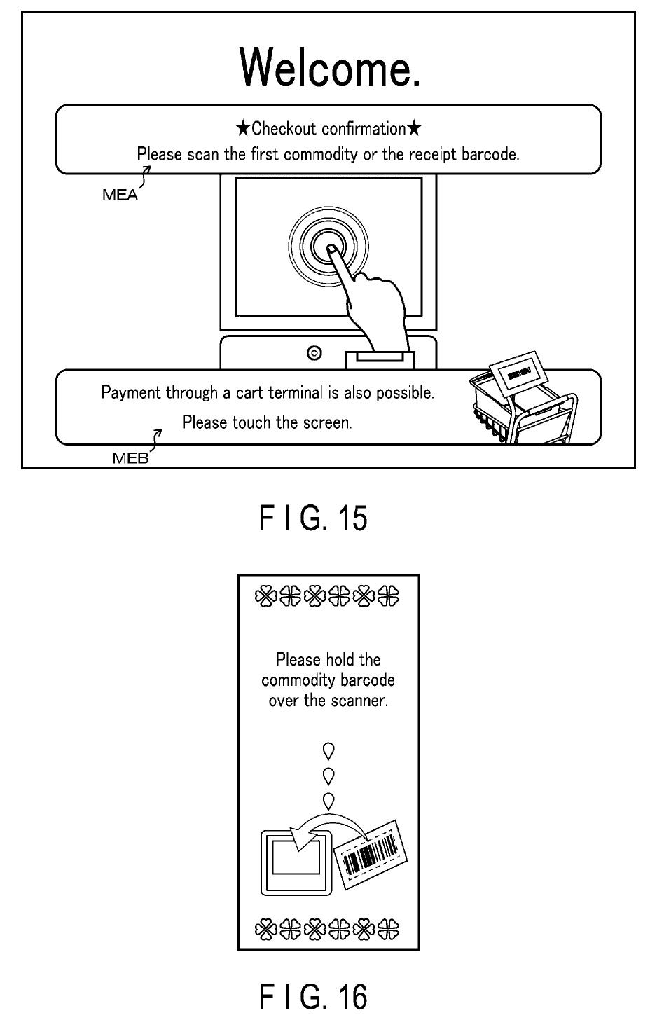

FIG. 15 is a screen showing an example of a standby screen displayed on the touch panel 404.

Note that the standby screen and various screens described later illustrate main display objects, and that illustration of some display objects may be omitted. For example, an image for having a user imagine an operation to be performed by the user may be included in the screen. The content of the various screens may be appropriately determined by, for example, a person who decides the specifications of the commodity sale system 1.

The standby screen illustrated in FIG. 15 includes text messages MEA and MEB. The text message MEA guides a customer CU who has completed settlement related to a transaction and is about to exit the store to scan the commodity barcode or the receipt barcode of one of the transaction commodities. The text message MEB guides a customer CU to touch the screen of the touch panel 404 in order to start settlement for the transaction commodities registered using the information processing terminal 500. The commodity barcode is a barcode that is displayed on a commodity and represents barcode information including a commodity code as an identifier of the commodity. The receipt barcode represents barcode information including a transaction code as an identifier of a transaction, and is a barcode displayed on the receipt. Typically, a one-dimensional barcode is used as the commodity barcode and the receipt barcode. However, another type of optically readable code such as a two-dimensional code may be used as the commodity barcode and the receipt barcode.

FIG. 16 is a diagram showing an example of a standby screen displayed on the display unit 405.

The standby screen illustrated in FIG. 16 is a screen for guiding a customer CU who has completed settlement related to a transaction and is about to exit the store to scan the commodity barcode of one of the transaction commodities.

As ACT 402 in FIG. 12, the processor 401 confirms whether a barcode has been scanned. In a case where the processor 401 cannot confirm that such an event has occurred, the processor 401 determines NO and proceeds to ACT 403.

As ACT 403, the processor 401 confirms whether the screen of the touch panel 404 has been tapped. In a case where the processor 401 cannot confirm that such an event has occurred, the processor 401 determines NO and proceeds to ACT 404.

As ACT 404, the processor 401 confirms whether a human has passed through the checkout lane LA. In a case where the processor 401 cannot confirm that such an event has occurred, the processor 401 determines NO and returns to ACT 402. The term "checkout lane LA” as used herein and the term "checkout lane LA" as used in the following description refer to a checkout lane LA facing the checkout gate 400, which is to be described.

Thus, as ACT 402 through ACT 404, the processor 401 waits for a barcode to be scanned, the screen to be tapped, or a human to pass through.

In a case where a plurality of checkout gates 400 are installed, a customer CU using the information processing terminal 500 displaying the transfer screen on the touch panel 504 as described above selects any one of the checkout gates 400 displaying the standby screen and touches the screen of the touch panel 504 of the checkout gate 400. When the touch panel 504 detects a tap, the processor 401 determines YES in ACT 403 and proceeds to ACT 405.

As ACT 405, the processor 401 causes the touch panel 404 and the display unit 405 to display a transfer guidance screen. The transfer guidance screen is a screen for guiding a customer CU to cause the handy scanner 407 to read the transfer code included in the transfer screen displayed on the touch panel 504 in the information processing terminal 500 as described above.

As ACT 406, the processor 401 waits for the transfer code to be scanned.

After touching the screen of the touch panel 504 as described above, a customer CU causes the reading port of the handy scanner 407 to face the transfer code. Accordingly, the handy scanner 407 reads the transfer code and outputs barcode information represented by the transfer code to the processor 401. In response, the processor 401 determines YES in ACT 406 and proceeds to ACT 407.

The transfer code may be read by the fixed scanner 406. That is, in a case where the information processing terminal 500 is detachable from a cart CA, or a portable information processing apparatus is used as the information processing terminal 500, for example, the touch panel 504 of the information processing terminal 500 may be made to face the fixed scanner 406. Also, the transfer guidance screen preferably guides a customer CU on an expected manner of reading the transfer code.

As ACT 407, the processor 401 obtains checkout data based on the transfer data represented by the barcode information output from the handy scanner 407. That is, the processor 401 requests checkout data from the transaction processing apparatus 100, as illustrated in FIG. 11.

When checkout data is requested from the checkout gate 400, the processor 101 in the transaction processing apparatus 100 proceeds to ACT 103.

As ACT 103, the processor 101 sends predetermined checkout data for billing and settlement corresponding to the content of a transaction represented by the transaction data to the checkout gate 400, which is the source of the request. Then, in ACT 407, the processor 401 in the checkout gate 400 imports the checkout data thus sent and received by the communication unit 412.

Once the processor 401 obtains the checkout data in this manner, the processor 401 proceeds to ACT 408 in FIG. 12.

As ACT 408, the processor 401 performs checkout processing based on the obtained checkout data. That is, the processor 401 performs, for example, billing processing for determining a payment amount related to a transaction of concern based on the obtained checkout data. This billing processing may be the same processing as that performed by, for example, a checkout machine of an existing semi-self-service-type POS system. The processor 401 then performs, for example, settlement processing for settling the payment amount determined as described above. As an example, it is assumed that the settlement processing is performed by applying electronic money uniquely provided by a company that operates the store. In this case, the identifier of a customer CU is obtained when the customer CU starts using the information processing terminal 500, for example, and the electronic money balance associated with the identifier is used to make the settlement. However, to make the settlement at the checkout gate 400, various payment methods such as credit card payment, code payment, prepaid payment, point payment, gift certificate payment, or cash payment may be appropriately adopted. Further, an electronic money payment method offered by a payment service provider different from a company operating the store may be employed for the settlement to be made at the checkout gate 400. Depending on the payment method available, a device that is necessary for a payment to be made through the payment method and is not illustrated in FIG. 6 may be additionally provided.

As ACT 409, the processor 401 confirms whether an electronic receipt is to be applied. In a case where the identifier of a customer CU has been obtained as described above, the processor 401 confirms whether the setting for applying an electronic receipt has been made in advance for the customer CU identified by the identifier. The processor 401 may have a customer CU designate whether or not to apply an electronic receipt, and then confirm whether an electronic receipt is to be applied in accordance with the designation. In a case where the processor 401 cannot confirm that an electronic receipt is to be applied, the processor 401 determines NO and proceeds to ACT 410.

As ACT 410, the processor 401 issues a paper receipt indicating a receipt barcode as well as the content of a transaction, a checkout result, and the like. That is, the processor 401, for example, generates a receipt image showing a settlement completion code as well as the content of a transaction, a checkout result, and the like, and causes the receipt printer 408 to print the receipt image. Accordingly, the receipt printer 408 prints the receipt image on a receipt sheet, and a paper receipt thus created is issued.

On the other hand, in a case where the processor 401 can confirm that an electronic receipt is to be applied, the processor 401 determines YES in ACT 409 and proceeds to ACT 411.

As ACT 411, the processor 401 registers, in the electronic receipt server 3, an electronic receipt including a receipt barcode as well as the content of a transaction, a checkout result, and the like. That is, the processor 401 transmits predetermined request data for requesting registration of an electronic receipt to the electronic receipt server 3 along with a notification of a settlement completion code as well as the content of a transaction, a checkout result, and the like. Upon receiving the request data, the electronic receipt server 3 makes it possible to view, from any information terminal, an electronic receipt screen showing a receipt barcode as well as the content of a transaction, a checkout result, and the like that have been reported.

Upon completing ACT 410 or ACT 411, in either case, the processor 401 proceeds to ACT 412.

As ACT 412, the processor 401 notifies the transaction processing apparatus 100 of a result of the checkout processing. In response to the notification, the processor 101 in the transaction processing apparatus 100 proceeds to ACT 104 in FIG. 11.

As ACT 104, the processor 401 sends transaction data relating to a transaction to be processed at this time to the POS server 700. The transaction data may be similar to transaction data in existing POS systems. That is, the transaction data may include a transaction header, item data, combination discount data, customer data, closing data, credit card data, and the like. The item data is data representing a list of transaction commodities. The type of data to be included in the transaction data may be appropriately determined by, for example, a person who decides the specifications of the commodity sale system 1. Note that the transaction data is data that makes it possible to at least determine what commodity has been traded in a transaction of concern. The processor 401 also includes, in the transaction data, exit data representing an exit status of a customer CU from the store as a state indicating that the customer CU has not exited the store.

Upon receiving the transaction data, the processor 701 in the POS server 700 proceeds to ACT 701.

As ACT 701, the processor 701 updates the transaction database DBA to include the transaction data.

After issuing a notification of a checkout result as ACT 412 in FIG. 12, the processor 401 in the checkout gate 400 proceeds to ACT 413.

As ACT 413, the processor 401 performs passage permission processing.

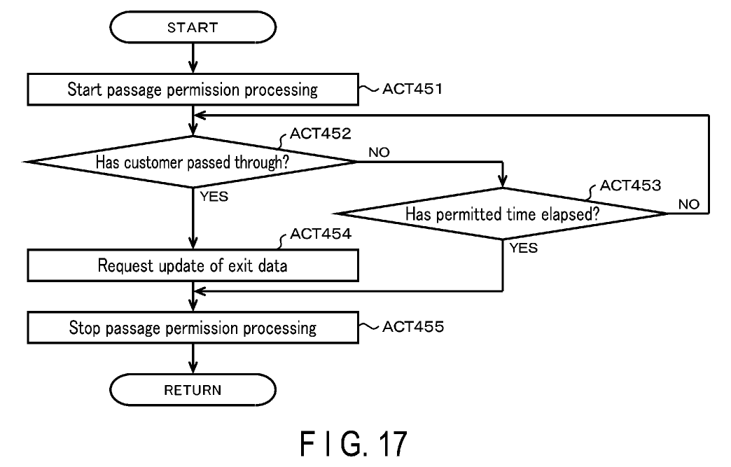

FIG. 17 is a flowchart of the passage permission processing.

As ACT 451, the processor 401 starts a passage permission notification. The passage permission notification is a notification for causing a customer CU and people around the customer CU to recognize that passing through the checkout lane LA is permitted. For the passage permission notification, the processor 401, for example, turns on the lamp unit 410 in blue. For the passage permission notification, the processor 401, for example, causes the sound unit 411 to output a voice message such as "Please pass through the gate." Alternatively, for the passage permission notification, the processor 401 may, for example, cause the sound unit 411 to perform a different operation such as outputting a predetermined notification sound. For the passage permission notification, the processor 401 may cause only some of these operations to be performed.

In addition to the above, the processor 401, for example, causes the touch panel 404 to display a first guidance screen in the passage permission notification. In addition to the above, the processor 401, for example, causes the display unit 405 to display a second guidance screen in the passage permission notification.

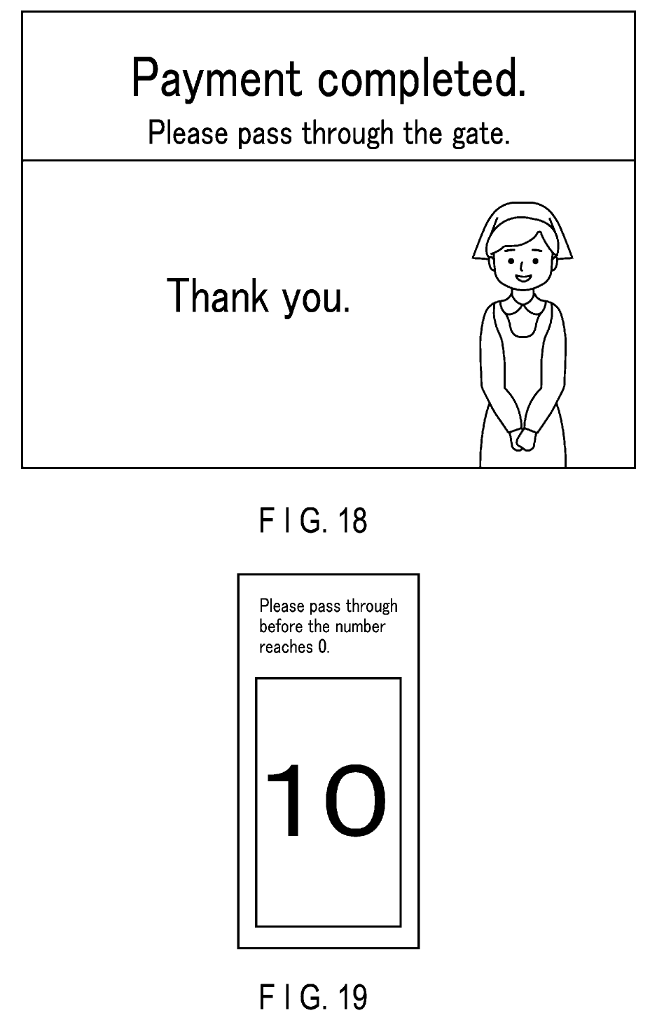

FIG. 18 is a diagram showing an example of a first guidance screen.

The first guidance screen illustrated in FIG. 18 includes a text message indicating that passing through the checkout lane LA is permitted because payment has been completed.

FIG. 19 is a diagram showing an example of a second guidance screen.

The second guidance screen illustrated in FIG. 19 includes a text message indicating that there is a limit to the time during which passing through the checkout lane LA is permitted and a number indicating the remaining time during which passing through the checkout lane LA is permitted. The second guidance screen illustrated in FIG. 19 is an example where the remaining time is 10 seconds, and the number "10" indicates the remaining time. The processor 401 updates the number indicating the remaining time every time the remaining time changes on the second guidance screen.

The second guidance screen makes it possible to recognize the remaining time in the period during which passing through the checkout lane LA is permitted. Based on this screen, a customer CU can determine, for example, whether the customer CU should hurry through the checkout lane LA.

All of the various displays and the various sound outputs illustrated here are examples of a notification indicating that a customer CU is permitted to pass through the checkout lane LA. Thus, the touch panel 404, the display unit 405, the lamp unit 410, and the sound unit 411 are examples of a notification unit.

The processor 401 proceeds to ACT 452 while performing the passage permission notification.

As ACT 452, the processor 401 confirms whether a human has passed through the checkout lane LA. In a case where the processor 401 cannot confirm that such an event has occurred, the processor 401 determines NO and proceeds to ACT 453.

As ACT 453, the processor 401 confirms whether a predetermined permitted time has elapsed since the processor 401 started the passage permission notification as ACT 451. In a case where the processor 401 cannot confirm that such an event has occurred, the processor 401 determines NO and returns to ACT 452.

Thus, as ACT 452 and ACT 453, the processor 401 waits for a human to pass through or a permitted time to elapse.

When a customer CU passes through the checkout lane before a permitted time elapses and the human-detecting sensor 409 thus detects the human passage, the processor 401 determines YES in ACT 452 and proceeds to ACT 454.

As ACT 454, the processor 401 requests the POS server 700 to update exit data. In response to the request, the processor 701 in the POS server 700 proceeds to ACT 702 in FIG. 11. The request for updating exit data may be made by the processor 601 to the POS server 700 in response to a notification of exit from the processor 401.

As ACT 702 in FIG. 11, the processor 701 updates the exit data included in the transaction data included in the transaction database DBA in ACT 701 to a state indicating completion of exit.

Upon completing the notification in ACT 454 in FIG. 17, the processor 401 in the checkout gate 400 proceeds to ACT 455. In a case where a permitted time elapses without a confirmation that a customer CU has passed through the checkout lane LA, the processor 401 determines YES in ACT 453, passes ACT 454, and proceeds to ACT 455. For example, even after payment is completed, a customer CU may return to a sales floor or the like without passing through the checkout lane LA; in such a case, the processor 401 determines YES in ACT 453.

As ACT 455, the processor 401 stops the passage permission notification. The processor 401 then ends the passage permission processing, returns to ACT 401 in FIG. 12, and prepares for the next customer CU.

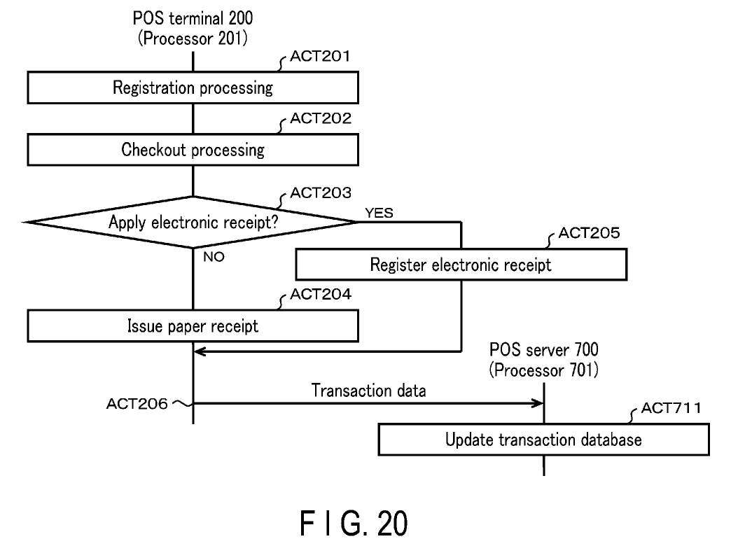

FIG. 20 is a sequence diagram relating to transaction processing using the POS terminal 200.

Upon receiving designation of a start of registration through a predetermined operation by a clerk CL, the processor 201 in the POS terminal 200 proceeds to ACT 201.

As ACT 201, the processor 201 registers commodities to be purchased by a customer CU as transaction commodities in accordance with an operation by a clerk CL using various devices of the POS terminal 200, and generates transaction data representing a list of the transaction commodities. When the completion of the registration is declared by the clerk CL, the processor 201 proceeds to ACT 202.

As ACT 202, the processor 201 performs checkout processing for billing and settlement corresponding to the content of a transaction represented by the transaction data generated in ACT 201. That is, the processor 201 performs, for example, billing processing for determining a payment amount related to a transaction of concern based on the generated transaction data. The processor 201 then performs, for example, settlement processing for settling the payment amount determined as described above. The settlement processing may be performed by using various payment methods such as credit card payment, code payment, prepaid payment, point payment, gift certificate payment, or cash payment as appropriate.

The above-described processing for registration and checkout may be the same as that performed by, for example, an existing face-to-face POS terminal.

In this manner, the POS terminal 200 functions as a settlement apparatus.

As ACT 203, the processor 201 confirms whether an electronic receipt is to be applied. In a case where the identifier of a customer CU has been obtained in the registration processing or the checkout processing, the processor 201 confirms whether the setting for applying an electronic receipt has been made in advance for the customer CU identified by the identifier. The processor 201 may have a customer CU or a clerk CL designate whether or not to apply an electronic receipt, and then confirm whether an electronic receipt is to be applied in accordance with the designation. In a case where the processor 201 cannot confirm that an electronic receipt is to be applied, the processor 201 determines NO and proceeds to ACT 204.

As ACT 204, the processor 201 issues a paper receipt indicating a receipt barcode as well as the content of a transaction, a checkout result, and the like. That is, the processor 201, for example, generates a receipt image showing the content of a transaction, a checkout result, and the like, and causes the receipt printer 210 to print the receipt image. Accordingly, the receipt printer 210 prints the receipt image on a receipt sheet, and a paper receipt thus created is issued.

On the other hand, in a case where the processor 201 can confirm that an electronic receipt is to be applied, the processor 201 determines YES in ACT 203 and proceeds to ACT 205.

As ACT 205, the processor 201 registers, in the electronic receipt server 3, an electronic receipt including a receipt barcode as well as the content of a transaction, a checkout result, and the like. That is, the processor 201 transmits predetermined request data for requesting registration of an electronic receipt to the electronic receipt server 3 along with a notification of the content of a transaction, a checkout result, and the like. Upon receiving the request data, the electronic receipt server 3 makes it possible to view, from any information terminal, an electronic receipt screen showing a receipt barcode as well as the content of a transaction, a checkout result, and the like that have been reported.

Upon completing ACT 204 or ACT 205, in either case, the processor 201 proceeds to ACT 206.

As ACT 206, the processor 201 sends transaction data relating to the transaction processed at this time to the POS server 700. The transaction data may be similar to the transaction data in existing POS systems. That is, the transaction data may include a transaction header, item data, combination discount data, customer data, closing data, credit card data, and the like. The item data is data representing a list of transaction commodities. The type of data to be included in the transaction data may be appropriately determined by, for example, a person who decides the specifications of the commodity sale system 1. Note that the transaction data is data that makes it possible to at least determine what commodity has been traded in a transaction of concern. In the present embodiment, a customer CU related to a transaction processed by the POS terminal 200 is excluded from exit control by the checkout gate 400, and operations are performed irrespective of the checkout gate 400. Thus, the processor 201 does not include exit data in the transaction data. That is, an existing face-to-face POS terminal may be directly used as the POS terminal 200.

Upon receiving the transaction data, the processor 701 in the POS server 700 proceeds to ACT 711.

As ACT 711, the processor 701 updates the transaction database DBA to include the transaction data.

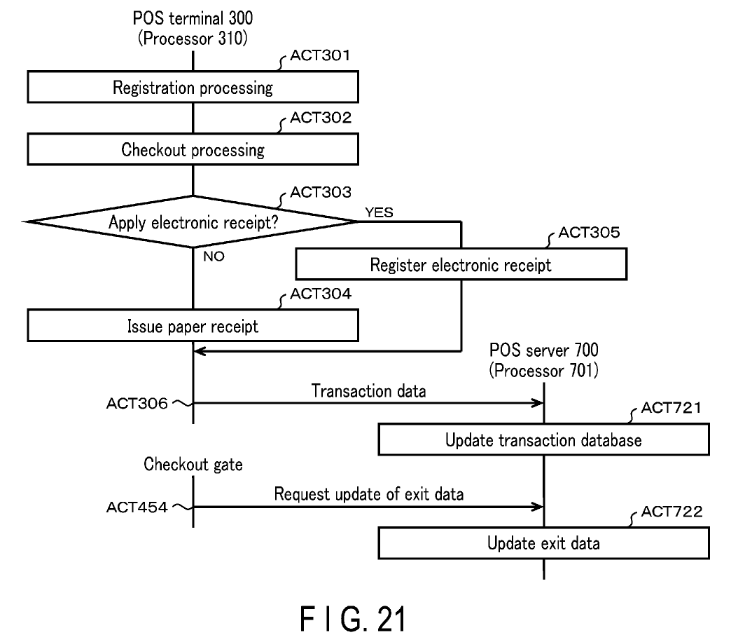

FIG. 21 is a sequence diagram relating to transaction processing using the POS terminal 300.

Upon receiving designation of a start of registration through a predetermined operation by a customer CU, the processor 301 in the POS terminal 300 proceeds to ACT 301.

As ACT 301, the processor 301 registers commodities to be purchased by a customer CU as transaction commodities in accordance with an operation by the customer CU using various devices of the POS terminal 300, and generates transaction data representing a list of the transaction commodities. For example, the processor 301 registers, as a transaction commodity, a commodity designated by a customer CU causing the fixed scanner 306 or the handy scanner 307 to read a barcode of the commodity, or by a customer CU operating a preset key that is displayed on the touch panel 304 or included in the keyboard 305 and associated with the commodity in advance. When the completion of the registration is declared by the customer CU, the processor 301 proceeds to ACT 302.

As ACT 302, the processor 301 performs checkout processing for billing and settlement corresponding to the content of a transaction represented by the transaction data generated in ACT 301. That is, the processor 301 performs, for example, billing processing for determining a payment amount related to a transaction of concern based on the generated transaction data. The processor 301 then performs, for example, settlement processing for settling the payment amount determined as described above. The settlement processing may be performed by using various payment methods such as credit card payment, code payment, prepaid payment, point payment, gift certificate payment, or cash payment as appropriate.

The above-described processing for registration and checkout may be the same as that performed by, for example, an existing full-self-service-type POS terminal.

In this manner, the POS terminal 300 functions as a settlement apparatus.

As ACT 303, the processor 301 confirms whether an electronic receipt is to be applied. In a case where the identifier of a customer CU has been obtained in the registration processing or the checkout processing, the processor 301 confirms whether the setting for applying an electronic receipt has been made in advance for the customer CU identified by the identifier. The processor 301 may have a customer CU designate whether or not to apply an electronic receipt, and then confirm whether an electronic receipt is to be applied in accordance with the designation. In a case where the processor 301 cannot confirm that an electronic receipt is to be applied, the processor 301 determines NO and proceeds to ACT 304.

As ACT 304, the processor 301 issues a paper receipt indicating a receipt barcode as well as the content of a transaction, a checkout result, and the like. That is, the processor 301, for example, generates a receipt image showing a receipt barcode as well as the content of a transaction, a checkout result, and the like, and causes the receipt printer 310 to print the receipt image. Accordingly, the receipt printer 310 prints the receipt image on a receipt sheet, and a paper receipt thus created is issued.

On the other hand, in a case where the processor 301 can confirm that an electronic receipt is to be applied, the processor 301 determines YES in ACT 303 and proceeds to ACT 305.

As ACT 305, the processor 301 registers, in the electronic receipt server 3, an electronic receipt including a receipt barcode as well as the content of a transaction, a checkout result, and the like. That is, the processor 301 transmits predetermined request data for requesting registration of an electronic receipt to the electronic receipt server 3 along with a notification of a receipt barcode as well as the content of a transaction, a checkout result, and the like. Upon receiving the request data, the electronic receipt server 3 makes it possible to view, from any information terminal, an electronic receipt screen showing a receipt barcode as well as the content of a transaction, a checkout result, and the like that have been reported.

Upon completing ACT 304 or ACT 305, in either case, the processor 301 proceeds to ACT 306.

As ACT 306, the processor 301 sends transaction data relating to the transaction processed at this time to the POS server 700. The transaction data may be similar to the transaction data in existing POS systems. That is, the transaction data may include a transaction header, item data, combination discount data, customer data, closing data, credit card data, and the like. The item data is data representing a list of transaction commodities. The type of data to be included in the transaction data may be appropriately determined by, for example, a person who decides the specifications of the commodity sale system 1. Note that the transaction data is data that makes it possible to at least determine what commodity has been traded in a transaction of concern. In the present embodiment, a customer CU related to a transaction processed by the POS terminal 300 is subject to exit control by the checkout gate 400. Thus, the processor 301 includes, in the transaction data, exit data in a state indicating that no exit has been made.

Upon receiving the transaction data, the processor 701 in the POS server 700 proceeds to ACT 721.

As ACT 721, the processor 701 updates the transaction database DBA to include the transaction data.

As described above, in a case where a customer CU who has completed settlement at the checkout gate 400 but has not passed through the checkout lane LA within a permitted time is about to exit the store without purchasing any additional commodities, the customer CU causes the fixed scanner 406 or the handy scanner 407 of any checkout gate 400 in a standby state to read a receipt barcode shown on an electronic receipt screen or a paper receipt issued at the checkout gate 400. That is, the fixed scanner 406 and the handy scanner 407 are examples of a reader that reads a receipt barcode, which is an example of an optically readable code.

A customer CU who has completed settlement at the POS terminal 300 causes the fixed scanner 406 or the handy scanner 407 of any checkout gate 400 in a standby state to read a receipt barcode shown on an electronic receipt screen or a paper receipt issued at the POS terminal 300.

In a case where it is difficult to cause the fixed scanner 406 or the handy scanner 407 to read a receipt barcode due to various circumstances such as when a paper receipt issued at the checkout gate 400 or the POS terminal 300 is lost or an electronic receipt screen cannot be displayed because a customer CU does not have a smartphone or the like, for example, the customer CU can utilize an exit confirmation function implemented through collation of transaction commodities. In the case of utilizing this function, the customer CU causes the fixed scanner 406 or the handy scanner 407 to read a commodity barcode of one of the transaction commodities settled.

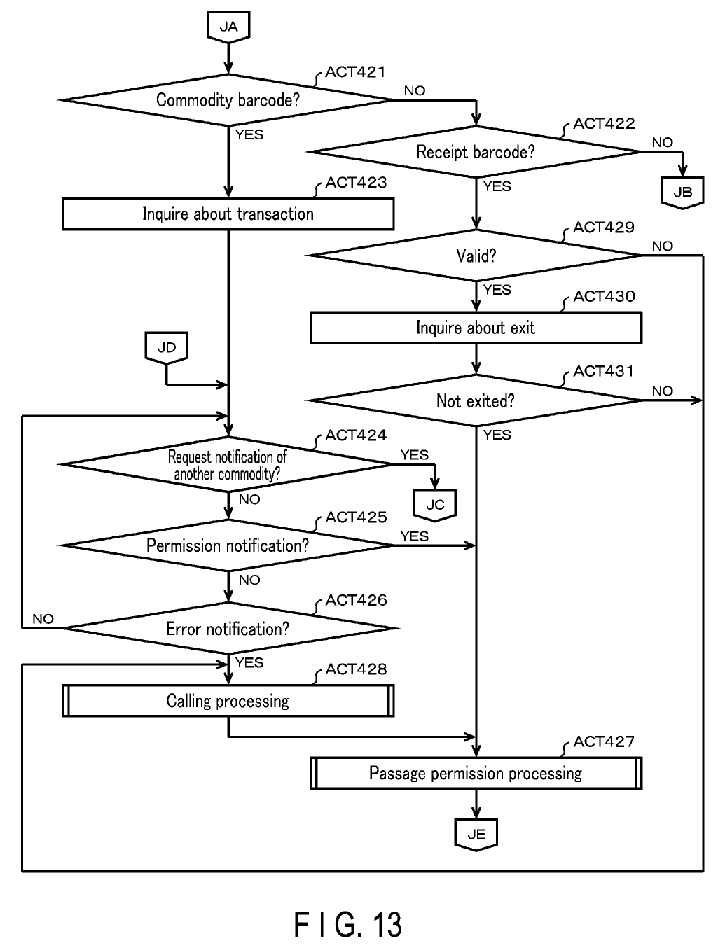

Upon reading a barcode, the fixed scanner 406 or the handy scanner 407 notifies the processor 401 of barcode information represented by the barcode. Accordingly, the processor 401 determines YES in ACT 402 in FIG. 12, and proceeds to ACT 421 in FIG. 13.

As ACT 421, the processor 401 confirms whether the read barcode is a commodity barcode. In a case where the processor 401 cannot confirm that the read barcode is a commodity barcode, the processor 401 determines NO and proceeds to ACT 422.

As ACT 422, the processor 401 confirms whether the read barcode is a receipt barcode. In a case where the processor 401 cannot confirm that the read barcode is a receipt barcode, the processor 401 determines NO and returns to the standby state in ACT 402 through ACT 404 in FIG. 5. At this time, the processor 401 may cause a guidance operation such as displaying a screen for guiding a customer CU to have a commodity barcode or a receipt barcode read to be performed.

In a case where a commodity barcode is read as described above, the processor 401 determines YES in ACT 421 and proceeds to ACT 423.

As ACT 423, the processor 401 inquires of the POS server 700 about a transaction along with a notification of a commodity code included in barcode information obtained by reading a commodity barcode.

In response to the inquiry about a transaction described above, the processor 701 in the POS server 700 performs information processing (hereinafter, referred to as “transaction search processing”) based on the transaction management program PRG.

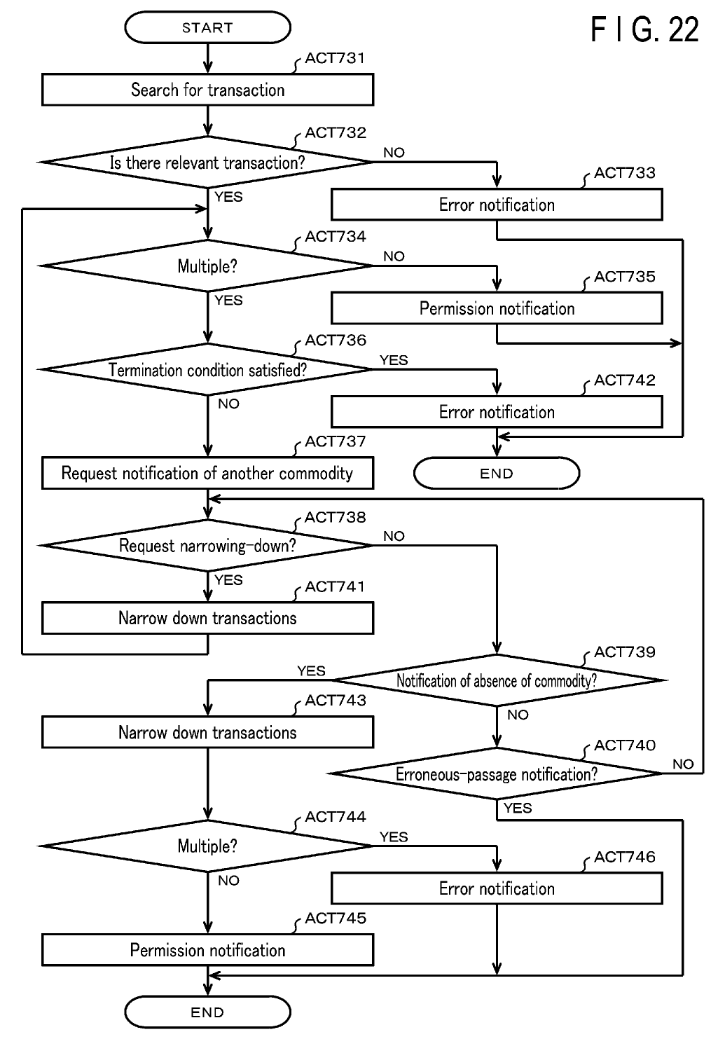

FIG. 22 is a flowchart of transaction search processing.

Hereinafter, in the description of the transaction search processing, "checkout gate 400" refers to a checkout gate 400 that has made the above-mentioned inquiry.

As ACT 731, the processor 701 searches past transactions for which settlement has been completed for a transaction that includes, as a transaction commodity, a commodity identified by a commodity code reported upon inquiry. For example, the processor 701 first extracts, from among pieces of transaction data included in the transaction database DBA, a piece of transaction data that matches the following conditions:
relating to a transaction performed within a predetermined search period;
including a commodity identified by a reported commodity code as a transaction commodity;
including exit data in a state indicating “not exited.”

As an example, a search period is assumed to be a fixed time span such as the most recent 10 minutes. The search period may be appropriately determined by a person who decides the specifications of the commodity sale system 1, a store manager, or the like. For example, the search period may be the day of a transaction. Also, a predetermined number of most recent transactions may be subject to search. In this case, the search period is a period in which a relevant number of transactions have been performed. As an example, the number of most recent transactions is assumed to be 20 transactions; however, the number of transactions may be appropriately determined by a person who decides the specifications of the commodity sale system 1, a store manager, or the like.

As ACT 732, the processor 701 confirms whether a relevant transaction has been found through the above-described search. In a case where the processor 701 cannot extract any transaction data that matches the conditions in ACT 731, for example, the processor 701 determines NO, determining that there is no relevant transaction, and proceeds to ACT 733.

As ACT 733, the processor 701 notifies the checkout gate 400 of an error in response to an inquiry about a transaction. That is, in a case where no transaction is found that matches the above conditions, the processor 701 determines that an error has occurred and notifies the checkout gate 400 of the error. The processor 701 then ends the transaction search processing.

In a case where the processor 701 can extract even a single piece of transaction data that matches the conditions in ACT 731, for example, the processor 701 determines YES in ACT 732, determining that there is a relevant transaction, and proceeds to ACT 734.

As ACT 734, the processor 701 confirms whether multiple transactions have been found through the above-described search. In a case where the processor 701 extracts only one piece of transaction data that matches the conditions in ACT 731, for example, the processor 701 determines NO, determining that no multiple pieces of transaction data have been found, and proceeds to ACT 735.

As ACT 735, the processor 701 notifies the checkout gate 400 of permission in response to an inquiry about a transaction. That is, in a case where the processor 701 successfully narrows down to a transaction based on the above conditions, the processor 701 makes a determination indicating permission, and notifies the checkout gate 400 of the permission. The processor 701 then ends the transaction search processing.

In a case where multiple pieces of transaction data are extracted in ACT 731, for example, the processor 701 determines YES in ACT 734 and proceeds to ACT 736.

As ACT 736, the processor 701 confirms whether a condition for terminating narrowing-down is satisfied. The termination condition may be appropriately determined by a person who decides the specifications of the commodity sale system 1, a store manager, or the like. A specific example of the termination condition will be described later. In a case where the processor 701 cannot confirm that a condition for terminating narrowing-down is satisfied, the processor 701 determines NO and proceeds to ACT 737.

As ACT 737, the processor 701 requests the checkout gate 400 to notify of another commodity.

After inquiring about a transaction as ACT 423 in FIG. 13, the processor 401 in the checkout gate 400 proceeds to ACT 424.

As ACT 424, the processor 401 confirms whether a notification of another commodity has been requested. In a case where the processor 401 cannot confirm that a notification of another commodity has been requested, the processor 401 determines NO and proceeds to ACT 425.

As ACT 425, the processor 401 confirms whether a permission notification has been made. That is, the processor 401 determines whether or not to receive a permission notification from the processor 701. In a case where the processor 401 cannot confirm that a permission notification has been made, the processor 401 determines NO and proceeds to ACT 426.

As ACT 426, the processor 401 confirms whether an error notification has been made. In a case where the processor 401 cannot confirm that an error notification has been made, the processor 401 determines NO and returns to ACT 424.

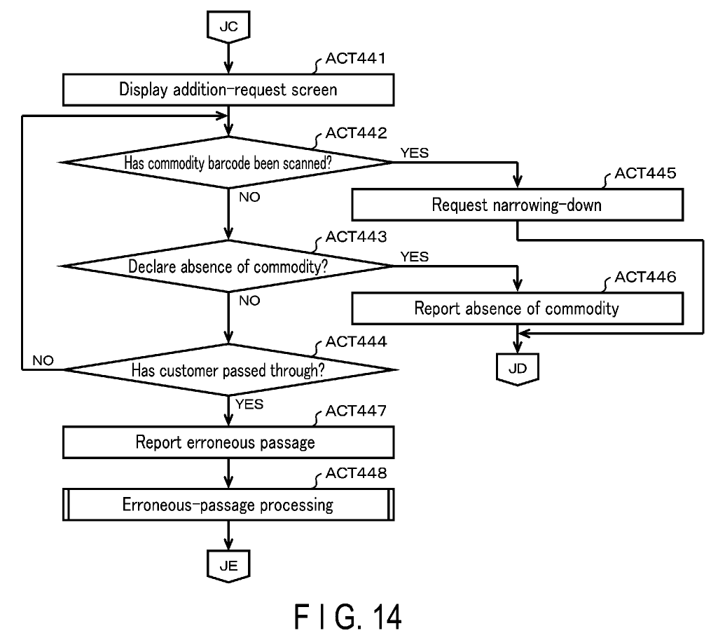

Thus, as ACT 424 through ACT 426, the processor 401 waits for any one of a notification request, a permission notification, or an error notification to be made. When a notification of another commodity is requested from the POS server 700 as described above, the processor 401 determines YES in ACT 424 and proceeds to ACT 441 in FIG. 14.

As ACT 441, the processor 401 causes the touch panel 404 to display an addition-request screen. The addition-request screen is a screen for requesting a customer CU to cause the fixed scanner 406 or the handy scanner 407 to read a commodity barcode of a transaction commodity different from a commodity barcode read so far.

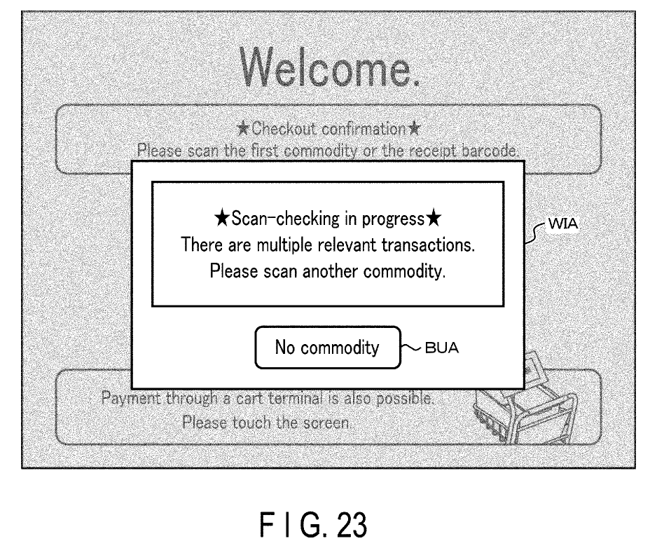

FIG. 23 is a diagram showing an example of an addition-request screen.

The addition-request screen illustrated in FIG. 23 is a screen with a window WIA displayed on the standby screen. The window WIA presents a text message for the request and also presents a button BUA. The button BUA is a soft key for a customer CU to declare that there is no other commodity.

In a case where there are other transaction commodities whose commodity codes have not been read yet, a customer CU causes the fixed scanner 406 or the handy scanner 407 to read a commodity barcode of a relevant transaction commodity. In a case where the commodity barcodes of all the transaction commodities have already been read, a customer declares that there is no commodity by performing a predetermined operation such as tapping the button BUA.

After causing the addition-request screen to be displayed as ACT 441 in FIG. 14, the processor 401 proceeds to ACT 442.

As ACT 442, the processor 401 confirms whether a commodity barcode has been scanned. In a case where the processor 401 cannot confirm that a commodity barcode has been scanned, the processor 401 determines NO and proceeds to ACT 443.

As ACT 443, the processor 401 confirms whether the absence of a commodity has been declared. In a case where the processor 401 cannot confirm that the absence of a commodity has been declared, the processor 401 determines NO and proceeds to ACT 444.

As ACT 444, the processor 401 confirms whether a customer CU has passed through the checkout lane LA. In a case where the processor 401 cannot confirm that a customer CU has passed through the checkout lane LA, the processor 401 determines NO and returns to ACT 442.

Thus, as ACT 442 through ACT 444, the processor 401 waits for any one of scanning of a commodity barcode, declaration of the absence of a commodity, or passage through to occur.

When a commodity barcode is read by the fixed scanner 406 or the handy scanner 407, the processor 401 determines YES in ACT 442 and proceeds to ACT 445.

As ACT 445, the processor 401 requests the POS server 700 to narrow down transactions along with a notification of a commodity code included in barcode information obtained by the fixed scanner 406 or the handy scanner 407 through the reading of a commodity barcode. Thereafter, the processor 401 returns to the standby state in ACT 424 through ACT 426 in FIG. 13.

Also, in response to the detection of an operation for declaring the absence of a commodity through the touch panel 404, for example, the processor 401 determines YES in ACT 443 and proceeds to ACT 446.

As ACT 446, the processor 401 notifies the POS server 700 that there is no commodity. Thereafter, the processor 401 returns to the standby state in ACT 424 through ACT 426 in FIG. 13.

After requesting a notification of another commodity as ACT 737 in FIG. 22, the processor 701 in the POS server 700 proceeds to ACT 738.

As ACT 738, the processor 701 confirms whether narrowing-downing has been requested. In a case where the processor 701 cannot confirm that narrowing-downing has been requested, the processor 701 determines NO and proceeds to ACT 739.

As ACT 739, the processor 701 confirms whether a notification of the absence of a commodity has been issued. In a case where the processor 701 cannot confirm that a notification of the absence of a commodity has been issued, the processor 701 determines NO and proceeds to ACT 740.

As ACT 740, the processor 701 confirms whether a notification of erroneous passage has been issued. In a case where the processor 701 cannot confirm that a notification of erroneous passage has been issued, the processor 701 determines NO and returns to ACT 738.

Thus, as ACT 738 through ACT 740, the processor 701 waits for any one of a request for narrowing-down, a notification of the absence of a commodity, or a notification of erroneous passage to be made. In a case where narrowing-down is requested as described above, the processor 701 determines YES in ACT 738 and proceeds to ACT 741.

As ACT 741, the processor 701 narrows down multiple transactions found in the search performed in ACT 731 to a transaction that includes, as transaction commodities, both a commodity identified by a commodity code reported upon inquiry and a commodity identified by a commodity code reported upon request for narrowing down. Thereafter, the processor 701 repeats ACT 734 and subsequent actions in the same manner as described above. Thus, in a case where the processor 701 cannot narrow down to a transaction in ACT 741, the processor 701 repeats the narrowing-down performed in ACT 741 while receiving a request for narrowing-down along with a notification of another commodity code. When performing ACT 741 for the second time or later, the processor 701 narrows down to a transaction that includes, as transaction commodities, a commodity identified by a commodity code reported upon inquiry and multiple commodities identified by commodity codes reported upon multiple requests for narrowing-down.

It is assumed that the termination condition that is confirmed by the processor 701 in ACT 736 is set as, for example, a case where the number of commodities used for narrowing down transactions reaches a specified number. In a case where the processor 701 cannot narrow down to a transaction even in a case where the termination condition is satisfied, the processor 701 determines YES in ACT 736 and proceeds to ACT 742. That is, in a case where there are multiple transactions performed with a prescribed number of commodities likewise included as transaction commodities, the processor 701 proceeds to ACT 742.

As ACT 742, the processor 701 notifies the checkout gate 400 of an error in response to an inquiry about a transaction. That is, in a case where the processor 701 cannot narrow down to a transaction even in a case where the termination condition is satisfied, the processor 701 determines that an error has occurred and notifies the checkout gate 400 of the error. The processor 701 then ends the transaction search processing.

In a case where the processor 701 is notified that there is no commodity as described above, the processor 701 determines YES in ACT 739 and proceeds to ACT 743.

As ACT 743, the processor 701 narrows down the multiple transactions obtained up to this point through the narrowing-down to a transaction whose items per transaction match the number of transaction commodities used for the narrowing-down performed so far. The items per transaction are represented, for example, in a transaction header included in transaction data.

As ACT 744, the processor 701 confirms whether multiple transactions have been found through the above-described narrowing-down. In a case where the processor 701 narrows down to a transaction, the processor 701 determines NO, determining that the number of transactions found is not plural, and proceeds to ACT 745.

As ACT 745, the processor 701 notifies the checkout gate 400 of permission in response to an inquiry about a transaction. That is, in a case where the processor 701 successfully narrows down to a transaction through the narrowing-down performed in ACT 743, the processor 701 makes a determination indicating permission, and notifies the checkout gate 400 of the permission. The processor 701 then ends the transaction search processing.

In a case where multiple transactions are found through the above-described narrowing-down, the processor 701 determines YES in ACT 744 and proceeds to ACT 746.

As ACT 746, the processor 701 notifies the checkout gate 400 of an error in response to an inquiry about a transaction. That is, in a case where a different transaction that has been performed for exactly the same transaction commodity as the transaction commodity of the transaction that is currently being inquired about is performed during the search period, the processor 701 determines that an error has occurred and notifies the checkout gate 400 of the error. The processor 701 then ends the transaction search processing.

Upon receiving the permission notification performed by the processor 701 in the POS server 700 in ACT 735 or ACT 745 as described above, the processor 401 in the checkout gate 400 determines YES in ACT 425 in FIG. 13 and proceeds to ACT 427.

As ACT 427, the processor 401 performs the passage permission processing in the same manner as in ACT 413 in FIG. 12. Upon completing the passage permission processing, the processor 401 returns to ACT 401 in FIG. 12.

Upon receiving the error notification performed by the processor 701 in the POS server 700 in ACT 733, ACT 742, or ACT 746 in FIG. 22 as described above, the processor 401 determines YES in ACT 426 in FIG. 13 and proceeds to ACT 428.

As ACT 428, the processor 401 performs calling processing. The calling processing is processing for calling a person in charge of handling an error at the checkout gate 400 (hereinafter, referred to as a “person in charge”) and receiving assistance from the person in charge.

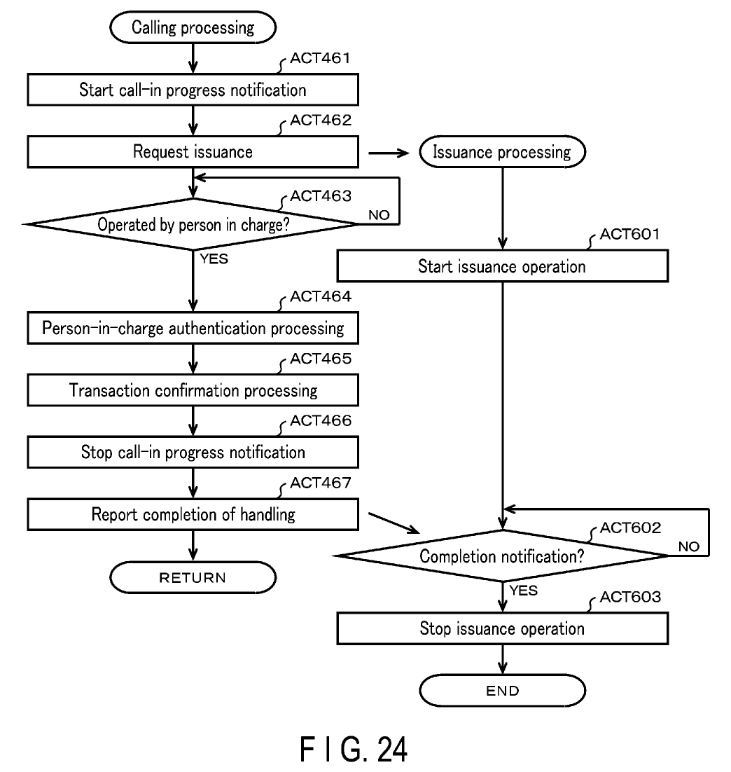

FIG. 24 is a flowchart of calling processing performed by the processor 401 in the checkout gate 400 and issuance processing performed by the processor 601 in the monitoring terminal 600.

As ACT 461, the processor 401 starts a call-in progress notification. The call-in progress notification is a notification to a customer CU that a clerk is being called. The processor 401 causes the touch panel 404 to display, for example, a call-in progress screen for the call-in progress notification. The processor 401 causes the display unit 405 to display, for example, a warning screen for the call-in progress notification. The processor 401, for example, turns on or causes to blink the lamp unit 410 in yellow for the call-in progress notification. The processor 401, for example, causes the sound unit 411 to output a predetermined notification sound for the call-in progress notification. Alternatively, the processor 401 may, for example, cause the sound unit 411 to perform a different operation such as outputting a predetermined voice message for the call-in progress notification. Note that the processor 401 may cause only some of these operations to be performed for the passage permission notification.

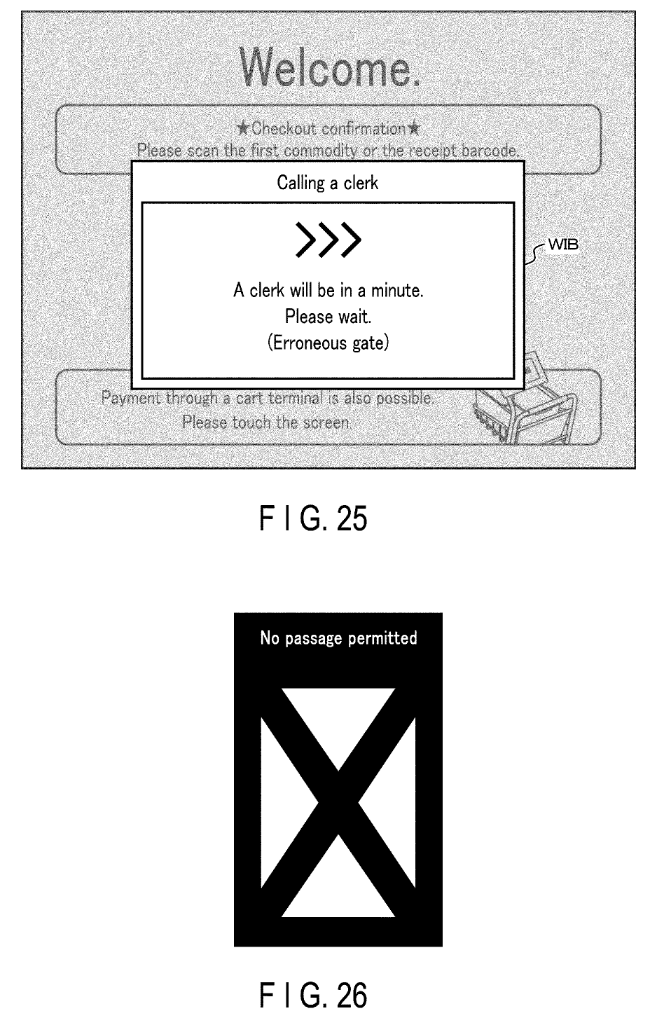

FIG. 25 is a diagram showing an example of a call-in progress screen.

The call-in progress screen illustrated in FIG. 25 is a screen with a window WIB displayed on the standby screen. The window WIB presents a text message for the above-mentioned guidance.

FIG. 26 is a diagram showing an example of a warning screen.

The warning screen illustrated in FIG. 26 is a screen for warning a customer CU in order to prevent the customer CU from exiting by mistake.

As ACT 462 in FIG. 24, the processor 401 requests a predetermined request destination to perform issuance. In the present embodiment, the monitoring terminal 600 is determined to be the issuance request destination.

The monitoring terminal 600 is installed at, for example, a store’s service counter. The monitoring terminal 600 performs an operation for transaction processing through the same operation as that of an existing POS terminal of the same type. Thus, the monitoring terminal 600 can be used to provide support when the POS terminal 200 is congested. The monitoring terminal 600 can also be used to respond to various requests by a customer CU such as return of goods.

When the issuance request made from the checkout gate 400 as described above is received, the processor 601 in the monitoring terminal 600 performs the issuance processing illustrated in FIG. 24 in accordance with the monitoring program PRF.

As ACT 601, the processor 601 starts an issuance operation. The issuance operation is an operation for issuing an instruction to a person in charge of monitoring using the monitoring terminal 600 to handle an error at the checkout gate 400. As the issuance operation, the processor 601, for example, causes the clerk-side touch panel 604 to display an issuance screen such that it is possible to recognize which checkout gate 400 has requested the issuance, and the issuance screen gives an instruction to handle an error at that checkout gate 400. As the issuance operation, the processor 601, for example, causes the sound unit 613 to output a predetermined issuance sound. Alternatively, as the issuance operation, the processor 601 may, for example, cause the sound unit 613 to perform a different operation such as outputting a predetermined voice message. Note that the processor 601 may cause only some of these operations to be performed as the issuance operation.

After requesting the issuance in ACT 462, the processor 401 in the checkout gate 400 proceeds to ACT 463.

As ACT 463, the processor 401 waits for a person in charge to start an operation.

A person in charge goes to the checkout gate 400 in accordance with the issuance operation performed at the monitoring terminal 600, and performs a predetermined operation that the person in charge should perform. In response to the performance of such an operation, the processor 401 determines YES in ACT 463 and proceeds to ACT 464.

As ACT 464, the processor 401 performs authentication processing for confirming that an operator is a person in charge. This authentication may be known processing for performing operator authentication. In a case where the authentication is successful, the processor 401 proceeds to ACT 465.

As ACT 465, the processor 401 performs transaction confirmation processing for causing a person in charge to confirm that the settlement of a transaction of a customer CU who is currently using the checkout gate 400 is completed. In the transaction confirmation processing, the processor 401, for example, causes the touch panel 404 to display a transaction confirmation screen showing the content of settled transactions. Then, the processor 401, for example, receives designation by the person in charge regarding which of the settled transactions is the current transaction of the customer CU.

As ACT 466, the processor 401 stops the call-in progress notification.

As ACT 467, the processor 401 notifies the monitoring terminal 600 of the completion of the handling. The processor 401 then ends the current calling processing and proceeds to ACT 427 in FIG. 13 to perform the passage permission processing in the same manner as described above.

After starting the issuance operation as ACT 601, the processor 601 in the monitoring terminal 600 proceeds to ACT 602.

As ACT 602, the processor 601 waits for a completion notification to be issued. When a completion notification is issued from the checkout gate 400 as described above, the processor 601 determines YES and proceeds to ACT 603.

As ACT 603, the processor 601 stops the issuance operation. The processor 601 then ends the current issuance processing.

In a case where a barcode that is read while the standby screen is being displayed is a receipt barcode, the processor 401 in the checkout gate 400 determines YES in ACT 422 in FIG. 13 and proceeds to ACT 429.

As ACT 429, the processor 401 confirms whether the read receipt barcode is valid for performing exit checking using the checkout gate 400. The processor 401 confirms whether the receipt barcode matches a predetermined condition, and determines that the receipt barcode is valid in a case where the receipt barcode matches the predetermined condition. The aforementioned condition is assumed to be, for example, a case where the receipt barcode concerned is a receipt barcode related to a transaction for which settlement has been processed by a device that is installed in the same store as the store where the checkout gate 400 is installed and is not a POS terminal included in the rejection list data DAB. However, the condition may be appropriately determined by a person who decides the specifications of the commodity sale system 1, a store manager, or the like. For example, only one of the aforementioned two conditions may be employed. Another condition may be added such as the time that has elapsed since the completion of the settlement of the transaction related to the receipt barcode being less than a specified time. In a case where the processor 401 can determine that the receipt barcode is valid, the processor 401 determines YES and proceeds to ACT 430. In the case of the present embodiment, the processor 401 proceeds to ACT 430 in a case where a receipt code related to a transaction for which settlement processing has been performed at the POS terminal 300, the checkout gate 400, or the monitoring terminal 600 is read.

A customer CU can cause the fixed scanner 406 or the handy scanner 407 to read a receipt barcode after the settlement is completed. That is, confirming that a read receipt barcode relates to a transaction settled by a device installed in the same store as the store where the checkout gate 400 is installed corresponds to confirming that the settlement is completed. Thus, with the processor 401 performing information processing based on the gate control program PRD, a computer having the processor 401 as a central part functions as a confirmation unit.

As ACT 430, the processor 401 inquires of the POS server 700 about the exit status of a customer CU along with a notification of a transaction code included in the barcode information represented by the read receipt barcode.

When such an inquiry about the exit status as described above is received, the processor 701 in the POS server 700 performs information processing (hereinafter, referred to as “exit confirmation processing”) based on the transaction management program PRG.

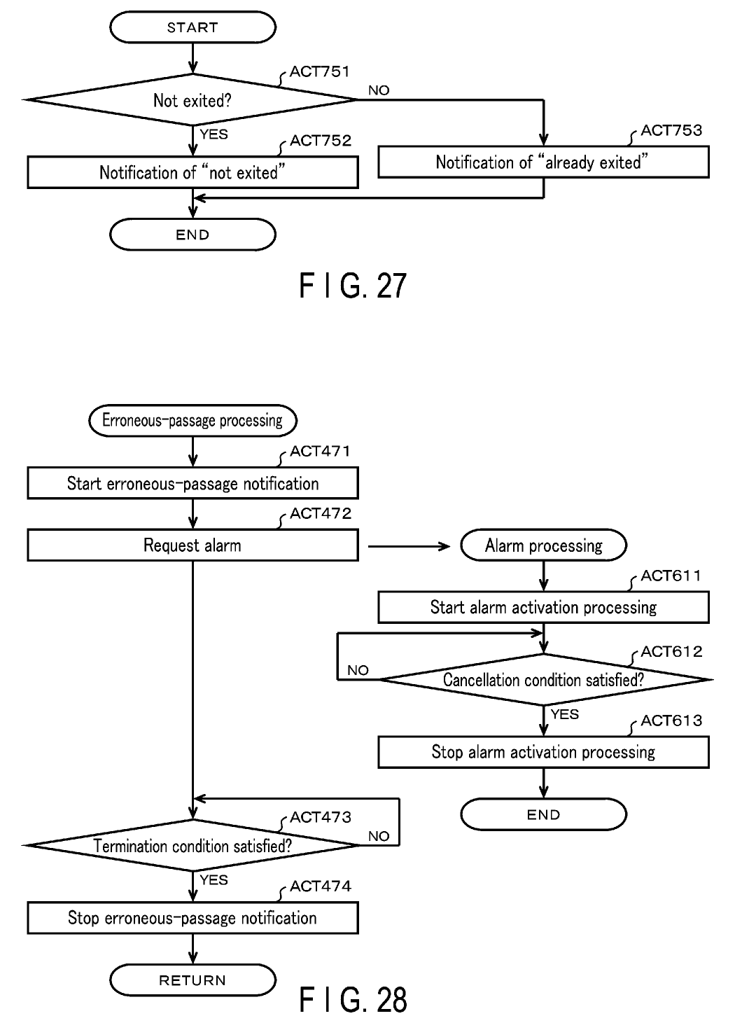

FIG. 27 is a flowchart of exit confirmation processing.

As ACT 751, the processor 701 confirms whether a customer CU related to a transaction identified by a reported transaction code has not exited the store. The processor 701, for example, searches the transaction database DBA for transaction data related to a transaction identified by a reported transaction code, and confirms whether the relevant exit data included in the transaction data is in a state indicating “not exited.” In a case where the relevant exit data is in a state indicating “not exited,” the processor 701 determines YES, determining that the customer CU has not exited the store, and proceeds to ACT 752.

As ACT 752, the processor 701 notifies the checkout gate 400 as an inquiry source that no exit has been made in response to an inquiry about the exit status.

In a case where the relevant exit data is not in a state indicating “not exited,” the processor 701 determines NO, determining that a customer CU has exited the store, and proceeds to ACT 753.

As ACT 753, the processor 701 notifies the checkout gate 400 as an inquiry source that a customer has exited in response to an inquiry about the exit status.

Upon completing the notification in ACT 752 or ACT 753, the processor 701 ends the current exit confirmation processing.

After making an inquiry as ACT 430 in FIG. 13, the processor 401 in the checkout gate 400 proceeds to ACT 431.

As ACT 431, the processor 401 confirms whether a notification indicating that no exit has been made has been issued. In a case where a notification indicating that no exit has been made is issued from the POS server 700 as described above, the processor 401 determines YES, proceeds to ACT 427, and performs passage permission processing in the same manner as described above.

In the case where the processor 401 determines YES in ACT 431 and proceeds to ACT 427 in this manner, the processor 401 executes control for performing notification in a case where the completion of the settlement is confirmed based on the fact that a receipt barcode as an example of a code has been read. Thus, with the processor 401 performing information processing based on the gate control program PRD, a computer having the processor 401 as a central part functions as a controller.

In a case where the processor 401 determines YES in ACT 431 and proceeds to ACT 427 as described above, the processor 401 issues a notification of a transaction code included in the barcode information represented by the read receipt barcode when requesting an update of the exit data in ACT 454 in FIG. 17. Upon receiving such a request, the processor 701 in the POS server 700 proceeds to, for example, ACT 722 in FIG. 21.

As ACT 722, the processor 701 searches the transaction database DBA for transaction data identified by a reported transaction code, and updates the exit data included in the relevant transaction data to a state indicating completion of exit.

In a case where the processor 401 cannot confirm that the read receipt barcode is valid for performing exit checking using the checkout gate 400, the processor 401 determines NO in ACT 429 in FIG. 13, determining that the read receipt barcode is invalid, proceeds to ACT 428, and performs the calling processing in the same manner as described above. Thus, in a case where a receipt barcode related to a transaction processed by the POS terminal 300 is read, for example, a clerk is called without permitting a customer to pass through.

Accordingly, depending on the function of the processor 401 as a controller, the notification may not be performed in a case where a settlement apparatus that has performed processing for the settlement of a transaction specified by a read code is excluded from exit control. Thus, the rejection list data DAB is an example of list data representing a list of the POS terminals 200 as settlement apparatuses that are excluded from exit control. The auxiliary storage unit 403 is an example of a storage.

In a case where a notification indicating that a customer has exited is issued from the POS server 700 as described above, the processor 401 determines NO in ACT 431, proceeds to ACT 428, and performs the calling processing in the same manner as described above. Thus, in a case where a receipt barcode related to a transaction for which an exit by a customer from the store has been confirmed is read, a clerk is called without permitting a customer to pass through.

In a case where a customer CU passes through the checkout lane LA when the processor 401 is in the standby state of ACT 402 through ACT 404 in FIG. 12, and the human-detecting sensor 409 detects it, the processor 401 determines YES in ACT 404, determining that passage has occurred, and proceeds to ACT 414.

As ACT 414, the processor 401 performs erroneous-passage processing.

On the other hand, in a case where a customer CU passes through the checkout lane LA when the processor 401 is in the standby state of ACT 442 through ACT 444 in FIG. 14, and the human-detecting sensor 409 detects it, the processor 401 determines YES in ACT 444, determining that passage has occurred, and proceeds to ACT 447.

As ACT 447, the processor 401 notifies the POS server 700 of erroneous passage.

As ACT 448, the processor 401 performs erroneous-passage processing

When the processor 401 is in the standby state of ACT 442 through ACT 444 in FIG. 14, the processor 701 in the POS server 700 is in the standby state of ACT 738 through ACT 740 in FIG. 22. Thus, upon receiving the above-mentioned notification of erroneous passage, the processor 701 determines YES in ACT 740 and ends the transaction search processing.

FIG. 28 is a flowchart of erroneous-passage processing performed by the processor 401 in the checkout gate 400 and alarm processing performed by the processor 601 in the monitoring terminal 600.

The erroneous-passage processing is a procedure illustrated in FIG. 28, whether it is performed as ACT 414 in FIG. 12 or performed as ACT 448 in FIG. 14.

As ACT 471, the processor 401 starts an erroneous-passage notification. The erroneous-passage notification is a notification to a customer CU and people around the customer CU that the customer CU has passed through the checkout lane LA through which the customer CU is not permitted to pass. The processor 401, for example, causes the touch panel 404 to display a first warning screen for the erroneous-passage notification. The processor 401, for example, causes the display unit 405 to display a second warning screen for the erroneous-passage notification. The processor 401, for example, turns on or causes to blink the lamp unit 410 in red for the erroneous-passage notification. The processor 401, for example, causes the sound unit 411 to output a predetermined alarm sound for the erroneous-passage notification. Alternatively, the processor 401 may, for example, cause the sound unit 411 to perform a different operation such as outputting a predetermined voice message for the erroneous-passage notification. Note that the processor 401 may cause only some of these operations to be performed for the erroneous-passage notification.

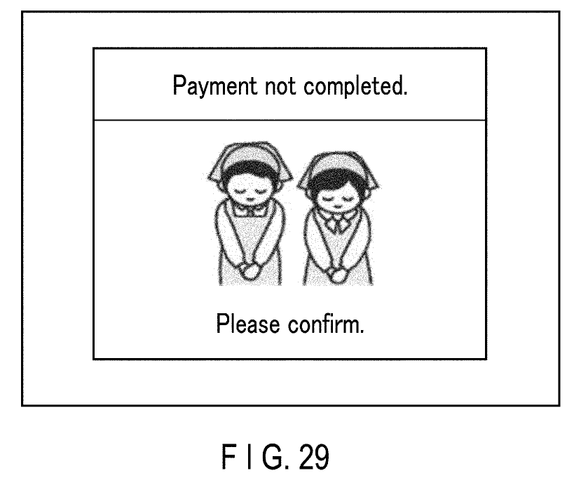

FIG. 29 is a diagram showing an example of the first warning screen.

The second warning screen is, for example, a screen similar to the warning screen illustrated in FIG. 26.

As ACT 472 in FIG. 28, the processor 401 requests a predetermined request destination to issue an alarm. In the present embodiment, the monitoring terminal 600 is determined to be the alarm request destination. When the alarm request made from the checkout gate 400 as described above is received, the processor 601 in the monitoring terminal 600 performs the alarm processing illustrated in FIG. 28 in accordance with the monitoring program PRF.

As ACT 611, the processor 601 starts alarm processing. The alarm processing is processing for issuing an alarm for unauthorized passage through the checkout lane LA to a clerk CL who is in charge of monitoring using the monitoring terminal 600. For the alarm processing, the processor 601, for example, causes the clerk-side touch panel 604 to display an alarm screen for making a clerk CL recognize unauthorized passage. The processor 601, for example, causes the sound unit 613 to output a predetermined alarm sound for the alarm processing. Alternatively, the processor 601 may, for example, cause the sound unit 613 to perform a different operation such as outputting a predetermined voice message for the alarm processing. Note that the processor 601 may cause only some of these operations to be performed for the alarm processing.

As ACT 612, the processor 601 waits for an alarm cancellation condition to be satisfied. The cancellation condition may be appropriately determined by, for example, a person who decides the specifications of the commodity sale system 1, an administrator of the monitoring terminal 600, or the like. The cancellation condition is assumed to be, for example, a case where cancellation is instructed through a predetermined operation performed at the clerk-side touch panel 604 or the keyboard 605. Alternatively, the cancellation condition is assumed to be a case where the duration of the alarm processing exceeds a predetermined time. In a case where the cancellation condition is satisfied, the processor 601 determines YES and proceeds to ACT 613.

As ACT 613, the processor 601 stops the alarm processing. The processor 601 then ends the current alarm processing.

After requesting an alarm in ACT 472, the processor 401 in the checkout gate 400 proceeds to ACT 473.

As ACT 473, the processor 401 waits for the condition for terminating the erroneous-passage notification to be satisfied. The termination condition may be appropriately determined by, for example, a person who decides the specifications of the commodity sale system 1, an administrator of the checkout gate 400, or the like. The termination condition is assumed to be, for example, a case where the duration of the erroneous-passage notification exceeds a predetermined time. Alternatively, the cancellation condition is assumed to be a case where an instruction to cancel the alarm processing has been given at the monitoring terminal 600. In this case, the processor 601 in the monitoring terminal 600 notifies the checkout gate 400 that a determination “YES” is made in ACT 612, determining that the cancellation condition is satisfied, in a case where the cancellation instruction is issued, and that the cancellation instruction has been issued before or after ACT 613. Alternatively, the termination condition is assumed to be a case where a predetermined cancellation operation has been performed by a clerk at the checkout gate 400. In a case where the termination condition is satisfied, the processor 401 determines YES and proceeds to ACT 474.

As ACT 474, the processor 401 stops the erroneous-passage notification. The processor 401 then ends the current erroneous-passage processing, and returns to ACT 401 in FIG. 12.

As described above, the checkout gate 400 excludes a customer CU related to a transaction processed by the POS terminal 200 from exit control. The checkout gate 400 does not permit a customer CU to pass through the checkout lane LA even in a case where the customer CU causes a receipt barcode related to a transaction settled by the POS terminal 200 to be read. Thus, the checkout gate 400 can provide appropriate guidance so as to prevent, for example, a customer CU who completed settlement at the POS terminal 200 and temporarily exited the store, or another customer CU who obtained a receipt discarded by such a customer, from re-entering the store and then using the receipt code related to the transaction to exit the store through the checkout lane LA.

The checkout gate 400 determines whether the POS terminals included in the list represented by the rejection list data DAB are subject to exit control. Thus, there is no need for each POS terminal to generate a receipt barcode to make it possible to determine whether the POS terminals are excluded from exit control, and existing ones can be used as-is.

The checkout gate 400 makes it possible to confirm, via the exit data, a transaction for which an exit by a customer CU through the checkout lane LA has been confirmed, and does not permit a customer CU to pass through the checkout lane LA even in a case where the customer CU causes a receipt barcode that is related to a transaction for which an exit by a customer CU from the store has been confirmed to be read. This allows the checkout gate 400 to provide appropriate guidance so as to prevent a customer from exiting the store using a receipt barcode that was used to legitimately exit through the checkout lane LA or using a receipt barcode shown on a receipt discarded by such a customer.

The embodiment can be modified in various ways as described below.

The determination of whether a settlement apparatus that has settled a transaction related to a read receipt barcode is excluded from exit control may be performed, for example, by another method described below instead of using the rejection list data DAB. For example, data indicating whether or not an apparatus is excluded from exit control may be included in barcode data represented by a receipt barcode, and such data may be referenced. Alternatively, for example, a code system of a receipt barcode or a system of a transaction number may be made different between a transaction that is subject to exit control and a transaction that is excluded from exit control, and it may be confirmed which system applies.

The confirmation of whether settlement has been completed may be performed, for example, by the checkout gate 400 inquiring of the POS server 700 whether settlement has been completed for a transaction identified by a transaction code included in a read barcode, and by the processor 701 in the POS server 700 referring to the transaction database DBA. In this case, a computer having the processor 701 as a central part functions as a confirmation unit. The function of a confirmation unit may be implemented by a computer installed in any information processing apparatus other than the POS server 700.

The checkout gate 400 may be configured such that a device having a function of a checkout machine and a device having a function of a gate are separate units.

A mechanism capable of selectively forming a state in which the checkout lane LA is physically blocked and a state in which the checkout lane LA is not blocked may be provided, and an opening and closing operation of the mechanism may be performed as one method of notification.

Registration of transaction commodities may be performed at the POS terminal 300, and checkout may be performed at the checkout gate 400.

The touch of the standby screen prior to a customer CU having a transfer code read may be omitted.

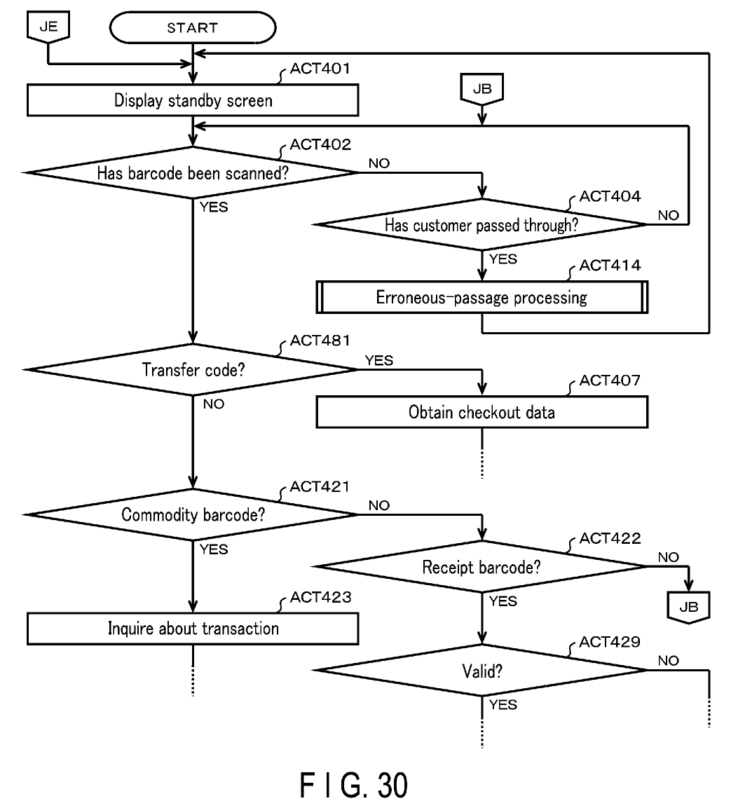

FIG. 30 is a diagram illustrating a modification of the gate control processing.

FIG. 30 shows only the changes from the gate control processing in FIGS. 12 and 13, and the same processing is denoted by the same reference numerals.

After causing the standby screen to be displayed as ACT 401, the processor 401 shifts to the standby state of ACT 402 and ACT 404 in FIG. 30 instead of the standby state of ACT 402 through ACT 404 in FIG. 12. That is, in this standby state, the processor 401 waits for a barcode to be scanned or for a human to pass through, and does not wait for a screen to be tapped.

Then, a customer CU causes the reading port of the handy scanner 407 to face a transfer code without touching the screen of the touch panel 504. Alternatively, a customer CU causes the fixed scanner 406 or the handy scanner 407 to read a receipt barcode or a commodity barcode. Thus, when a notification of barcode information is issued from the fixed scanner 406 or the handy scanner 407, the processor 401 proceeds to ACT 481.

As ACT 481, the processor 401 confirms whether a read barcode is a transfer code. In a case where the processor 401 can confirm that a read barcode is a transfer code, the processor 401 determines YES and performs ACT 407 and subsequent steps in the same manner as described above.

In a case where the processor 401 cannot confirm that a read barcode is a transfer code, the processor 401 determines NO in ACT 481 and proceeds to ACT 421. Then, the processor 401 performs ACT 421 and subsequent steps in the same manner as described above.

In the case of implementing such a modification, it is preferable to change the standby screen as well.

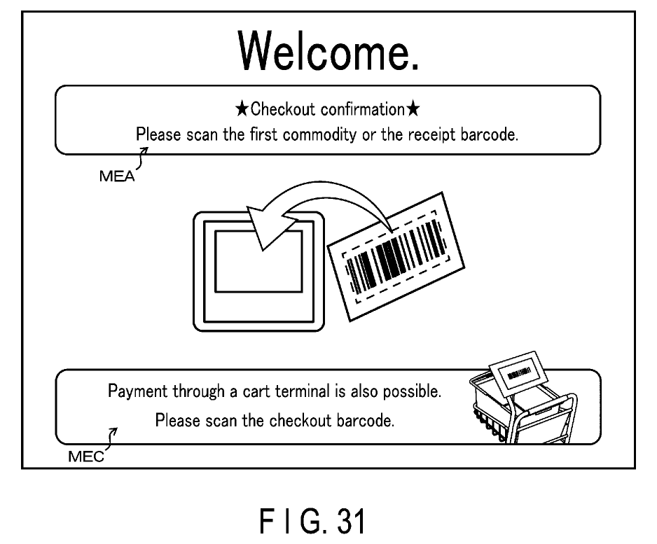

FIG. 31 is a diagram showing an example of a standby screen adapted to this modification.

The standby screen illustrated in FIG. 31 includes text messages MEA and MEC. That is, the standby screen illustrated in FIG. 31 presents the text message MEC instead of the text message MEB on the standby screen illustrated in FIG. 15. The text message MEC guides a customer CU to have a transfer barcode read in order to start settlement for transaction commodities registered using the information processing terminal 500.

The illustration in the center of the standby screen in FIG. 31, which replaces the one in FIG. 15, gives a customer CU an image of an operation of having a read barcode.

The functions realized by each processor through information processing may be implemented, in whole or in part, by hardware that performs information processing not based on programs, such as logic circuits. Each of these functions may also be realized by combining software control with such hardware as logic circuits.

Each of one or more circuits constituting the processing circuit executes one or more of the plurality of processes. In a case where the processing circuit is constituted by a single circuit, the single circuit executes all of the plurality of processes. In a case where the processing circuit is constituted by multiple circuits, each of the multiple circuits executes a part of the plurality of processes. A part of the plurality of processes may be one of the plurality of processes or two or more of the plurality of processes. In a case where the processing circuit is constituted by multiple circuits, the multiple circuits may be included in a single apparatus or distributed across multiple apparatuses.

The programs according to the embodiments may be transferred in the state of being stored in a device or transferred in the state of not being stored in a device. In the latter case, the programs may be transferred via a network or may be transferred in the state of being recorded on a recording medium. The recording medium is a non-transient tangible medium. The recording medium is a computer-readable medium. The recording medium may be any form of a medium that is capable of storing a program and readable by a computer, such as a CD-ROM or a memory card.

While certain embodiments have been described, they have been presented by way of example only, and they are not intended to limit the scope of the inventions. The novel embodiments described herein can be implemented in a variety of other forms; furthermore, various omissions, substitutions, and changes can be made without departing from the spirit of the invention. The accompanying claims and their equivalents are intended to cover such embodiments or modifications as would fall within the scope and spirit of the inventions.

Some of the above embodiments may be expressed as follows:

(1) A gate apparatus comprising:
a notification unit configured to issue a notification indicating that passage of a customer is permitted;
a reader configured to read an optically readable code;
a confirmation unit configured to confirm, based on the code read by the reader, whether or not settlement has been completed; and
a controller configured to control, in response to the code being read by the reader, the notification unit to issue the notification in a case where the confirmation unit confirms that the settlement has been completed;
wherein the controller controls the notification unit to not issue the notification in a case where a settlement apparatus that has performed processing for settlement of a transaction identified by the code read by the reader is excluded from exit control.

(2) The gate apparatus of (1), further comprising a storage storing list data representing a list of settlement apparatuses that are excluded from the exit control,
wherein the controller controls the notification unit to not issue the notification in a case where a settlement apparatus that has performed processing for settlement of a transaction identified by the code read by the reader is included in the list represented by the list data stored in the storage.

(3) The gate apparatus of (1), wherein the controller controls the notification unit to not issue the notification upon confirming that the customer has exited a store based on the code read by the reader.

(4) A program recording medium having an information processing program recorded thereon,
the information processing program causing a computer provided in a gate apparatus to realize functions,
the gate apparatus comprising:
a notification unit configured to issue a notification indicating that passage of a customer is permitted;
a reader configured to read an optically readable code;
the functions including:
a confirmation function of confirming, based on the code read by the reader, whether or not settlement has been completed; and
a control function of controlling, in response to the code being read by the reader, the notification unit to issue the notification in a case where the confirmation function confirms that the settlement has been completed,
wherein the control function controls the notification unit to not issue the notification in a case where a settlement apparatus that has performed processing for settlement of a transaction identified by the code read by the reader is excluded from exit control.

(5) A checkout system comprising:
a notification unit configured to issue a notification indicating that passage of a customer is permitted;
a reader configured to read an optically readable code;
a confirmation unit configured to confirm, based on the code read by the reader, whether or not settlement has been completed; and
a controller configured to control the notification unit to issue a notification in a case where the confirmation unit confirms that the settlement has been completed,
wherein the controller controls the notification unit to not issue the notification in a case where a settlement apparatus that has performed processing for settlement of a transaction identified by the code read by the reader is excluded from exit control.

What is claimed is:

1. A gate apparatus comprising:
a notification unit configured to issue a notification indicating that passage of a customer is permitted;
a reader configured to read an optically readable code;
a confirmation unit configured to confirm, based on the code read by the reader, whether or not settlement has been completed; and
a controller configured to control, in response to the code being read by the reader, the notification unit to issue the notification in a case where the confirmation unit confirms that the settlement has been completed;
wherein the controller controls the notification unit to not issue the notification in a case where a settlement apparatus that has performed processing for settlement of a transaction identified by the code read by the reader is excluded from exit control.

2. The gate apparatus according to claim 1, further comprising a storage storing list data representing a list of settlement apparatuses that are excluded from the exit control,
wherein the controller controls the notification unit to not issue the notification in a case where a settlement apparatus that has performed processing for settlement of a transaction identified by the code read by the reader is included in the list represented by the list data stored in the storage.

3. The gate apparatus according to claim 1, wherein the controller controls the notification unit to not issue the notification upon confirming that the customer has exited a store based on the code read by the reader.

4. A non-transitory computer-readable recording medium having an information processing program recorded thereon,
the information processing program causing a computer provided in a gate apparatus to realize functions,
the gate apparatus comprising:
a notification unit configured to issue a notification indicating that passage of a customer is permitted; and
a reader configured to read an optically readable code;
the functions including:
a confirmation function of confirming, based on the code read by the reader, whether or not settlement has been completed; and
a control function of controlling, in response to the code being read by the reader, the notification unit to issue the notification in a case where the confirmation unit confirms that the settlement has been completed,
wherein the control function controls the notification unit to not issue the notification in a case where a settlement apparatus that has performed processing for settlement of a transaction identified by the code read by the reader is excluded from exit control.

5. A checkout system comprising:
a notification unit configured to issue a notification indicating that passage of a customer is permitted;
a reader configured to read an optically readable code;
a confirmation unit configured to confirm, based on the code read by the reader, whether or not settlement has been completed; and
a controller configured to control the notification unit to issue a notification in a case where the confirmation unit confirms that the settlement has been completed,
wherein the controller controls the notification unit to not issue the notification in a case where a settlement apparatus that has performed processing for settlement of a transaction identified by the code read by the reader is excluded from exit control.
